(19) United States
(12) Patent Application Publication
(10) Pub. No.: US 2016/0055826 A1
(43) Pub. Date: Feb. 25, 2016

(54) IMAGE DISPLAY SYSTEM, TERMINAL, AND IMAGE DISPLAY APPARATUS

(71) Applicants: Sachiko ABE, Tokyo (JP); Kei OYAMADA, Kanagawa (JP)

(72) Inventors: Sachiko ABE, Tokyo (JP); Kei OYAMADA, Kanagawa (JP)

(73) Assignee: RICOH COMPANY, LTD., Tokyo (JP)

(21) Appl. No.: 14/820,603

(22) Filed: Aug. 7, 2015

(30) Foreign Application Priority Data
Aug. 21, 2014 (JP) 2014-168217

(51) Int. Cl. G09G 5/12

(52) U.S. Cl. CPC G09G 5/12; G09G 2370/20

(57) ABSTRACT

An image display system in which a terminal and a plurality of image display apparatuses are connected to each other via a network, includes a first sending unit configured to send an identifier that identifies each of the plurality of image display apparatuses, to the terminal; a determining unit configured to determine at least one of the plurality of image display apparatuses based on the received identifier; a second sending unit configured to send a content from the terminal to the at least one of the plurality of image display apparatuses that has been determined; and a first display unit configured to display the received content on a screen of the at least one of the plurality of image display apparatuses.

### BACKGROUND OF THE INVENTION

1. Field of the Invention

The present invention relates to an image display system, a terminal, and an image display apparatus.

2. Description of the Related Art

Generally, in conferences, etc., a terminal such as a PC (Personal Computer) and an image display apparatus such as a projector are connected, and the image data, etc., held by the terminal is displayed in the image display apparatus. Furthermore, there is already known a technology of connecting the terminal and the image display apparatus by a network such as a wired LAN (Local Area Network) or a wireless LAN, etc., instead of using a video transmission cable such as an RGB cable.

When the terminal and the image display apparatus are connected in an environment in which a plurality of image display apparatuses are installed, in a case where a video transmission cable is used to directly connect the terminal and the image display apparatus, the image display apparatus that is the connection destination can be confirmed visually, and therefore is unlikely that the terminal is connected to the wrong image display apparatus. However, when the terminal and the image display apparatus are connected via a network, the image display apparatus that is the connection destination is generally selected based on information such as an IP address, and therefore according to a setting mistake or carelessness, it is very well likely that the terminal is connected to the wrong image display apparatus.

In an environment in which a plurality of image display apparatuses are installed, it has been difficult to connect the terminal to the appropriate image display apparatus via a network. Furthermore, it has been difficult to identify the image display apparatus to which the terminal is connected, among a plurality of image display apparatuses.

Patent Document 1: Japanese Laid-Open Patent Publication No. 2004-54134

Patent Document 2: Japanese Laid-Open Patent Publication No. 2009-296661

Patent Document 3: Japanese Laid-Open Patent Publication No. 2012-198640

### SUMMARY OF THE INVENTION

The present invention provides an image display system, a terminal, and an image display apparatus, in which one or more of the above-described disadvantages are eliminated.

According to an aspect of the present invention, there is provided an image display system in which a terminal and a plurality of image display apparatuses are connected to each other via a network, the image display system including a first sending unit configured to send an identifier that identifies each of the plurality of image display apparatuses, to the terminal; a determining unit configured to determine at least one of the plurality of image display apparatuses based on the received identifier; a second sending unit configured to send a content from the terminal to the at least one of the plurality of image display apparatuses that has been determined; and a first display unit configured to display the received content on a screen of the at least one of the plurality of image display apparatuses.

According to an aspect of the present invention, there is provided a terminal connected to a plurality of image display apparatuses via a network, the terminal including a determining unit configured to determine at least one of the plurality of image display apparatuses based on identifiers received from the plurality of image display apparatuses; and a sending unit configured to send, to the at least one of the plurality of image display apparatuses that has been determined, a content to be displayed on a screen of the at least one of the plurality of image display apparatuses.

According to an aspect of the present invention, there is provided an image display apparatus connected to a terminal via a network, the image display apparatus including a sending unit configured to send an identifier that identifies the image display apparatus, to the terminal; a communication unit configured to receive a content from the terminal, the content being sent from the terminal that has determined to send the content to the image display apparatus based on the identifier; and a display unit configured to display the content.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of a network configuration of an image display system according to a first embodiment;

FIG. 2 illustrates an example of a hardware configuration of an image display apparatus;

FIG. 3 illustrates an example of a hardware configuration of a terminal;

FIG. 4 illustrates an example of a functional block configuration of the image display apparatus according to the first embodiment;

FIG. 5 illustrates a functional block configuration of the terminal according to the first embodiment;

FIG. 6 is a sequence diagram illustrating an example of processing procedures for registering a certificate;

FIGS. 7A and 7B illustrate examples of an identifier list;

FIGS. 8A and 8B illustrate examples of a connection terminal list;

FIG. 9 is a sequence diagram illustrating an example of processing procedures for sending the screen capture of the terminal to an image display apparatus by using a certificate;

FIG. 10 is a sequence diagram illustrating an example of processing procedures for registering the image display apparatus address;

FIG. 11 is a sequence diagram illustrating an example of processing procedures for sending the screen capture of the terminal to an image display apparatus by using an image display apparatus address;

FIG. 12 illustrates an example of an identifier list used in the screen transmission possibility determination process (modified example 1);

FIG. 13 is a flowchart of an example of processing procedures of the screen transmission possibility determination process (modified example 1);

FIG. 14 illustrates an example of an identifier list used in the screen transmission possibility determination process (modified example 2);

FIG. 15 illustrates an example of a validity period setting screen;

FIG. 16 is as flowchart of an example of processing procedures of the screen transmission possibility determination process (modified example 2);

FIG. 17 illustrates an example of an identifier list used in the screen transmission possibility determination process (modified example 3);

FIG. 18 is as flowchart of an example of processing procedures of the screen transmission possibility determination process (modified example 3);

FIG. 19 illustrates an example of processing procedures of the identifier registration process (modified example 1);

FIG. 20 illustrates an example of an identifier list used in the identifier registration process (modified example 2);

FIG. 21 illustrates an example of processing procedures of the identifier registration process (modified example 2);

FIG. 22 illustrates an example of processing procedures of the registration release process;

FIG. 23 illustrates an example of a display screen in a case where the registration state has been released;

FIG. 24 illustrates an example of a network configuration of an image display system according to a second embodiment;

FIG. 25 illustrates an example of a functional block configuration of the image display apparatus according to the second embodiment;

FIG. 26 illustrates an example of a functional block configuration of the terminal according to the second embodiment;

FIG. 27 is a sequence diagram illustrating an example of processing procedures for displaying the acquired image on the terminal;

FIGS. 28A through 28C illustrate examples of displayed image information;

FIG. 29 illustrates examples of acquired images displayed on the screen of the terminal;

FIG. 30 is a sequence diagram illustrating an example of processing procedures for sending a content from the terminal to the image display apparatus;

FIG. 31 is a sequence diagram illustrating an example of processing procedures for displaying an image file stored in a storage medium on the screen of the image display apparatus; and

FIG. 32 is a sequence diagram illustrating an example of processing procedures for confirming the connection between the terminal and the image display apparatus.

### DETAILED DESCRIPTION OF THE PREFERRED EMBODIMENTS

A description is given, with reference to the accompanying drawings, of embodiments of the present invention. In the drawings, the same elements are denoted by the same reference numerals, and overlapping descriptions may be omitted.

### First Embodiment

### 1. Overview

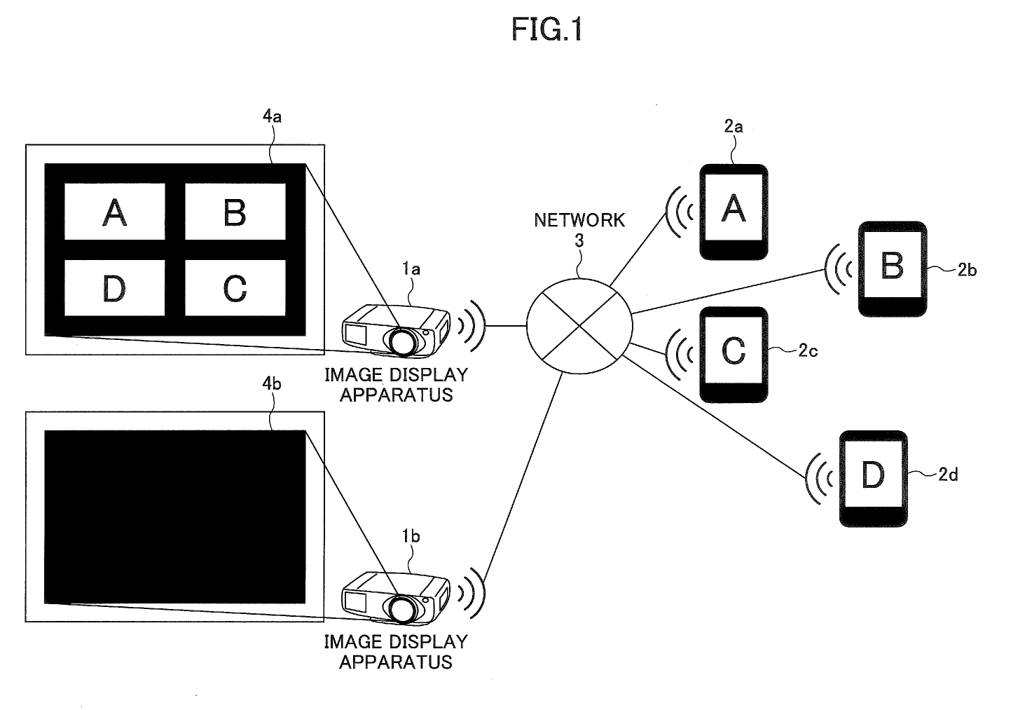

FIG. 1 illustrates an example of a network configuration of an image display system according to a first embodiment. Image display apparatuses 1a and 1b (hereinafter, “image display apparatus 1” when collectively referring to a plurality of image display apparatuses), and terminals 2a, 2b, 2c, and 2d (hereinafter, “terminal 2” when collectively referring to a plurality of terminals) are connected to each other via the network 3. The image display system according to the first embodiment includes two image display apparatuses 1 and four terminals 2; however, there may be one or three or more image display apparatuses 1 and one through three or five or more terminals 2.

The image display apparatus 1 acquires an image included in each terminal 2, and displays the image on a screen which is formed by irradiating a screen with light from a light source 107. In FIG. 1, the images of four terminals 2, i.e., the terminal 2a, the terminal 2b, the terminal 2c, and the terminal 2d, are processed to be displayed on one screen of the image display apparatus 1a; one display area 4a is divided into a plurality of areas (here, divided into four areas), and the images are displayed in the respective divided areas.

The terminal 2 sends, to the image display apparatus 1, an image file 412 stored in the terminal 2 itself, or an image file 412, etc., which has been acquired via a network 3 such as the Internet.

The network 3 is, for example, a LAN (Local Area Network), a wireless LAN, WAN (Wide Area Network), an exclusive line, or the Internet, and the network 3 sends communication packets that are sent and received between the image display apparatus 1 and the terminal 2.

Here, a description is given of the background of the image display system according to the first embodiment.

It is assumed that an image that is displayed on the screen of the terminal 2 is displayed on the screen of the image display apparatus 1 via a the network 3, and the terminal 2 determines the timing of capturing the screen of the terminal 2 by itself and sends the image to the image display apparatus 1. In this case, images of a plurality of terminals 2 are displayed on the screen of the image display apparatus 1 at the same time, and therefore there are cases where the load is concentrated on the image display apparatus 1.

In order to prevent the load from concentrating on the image display apparatus 1, the timing of sending the image of the terminal 2 may be determined by the image display apparatus 1. However, unless the terminal 2 can determine which image display apparatus 1 it is connected to, the terminal 2 may send an image to an unintended image display apparatus 1, which may cause a problem in terms of security.

Thus, in the image display system according to the first embodiment, the terminal 2 performs simple communication with respect to the image display apparatus 1, such that the terminal 2 can identify the image display apparatus 1.

Specifically, the terminal 2 stores identifiers for identifying the respective image display apparatuses 1. When the image display apparatus 1 requests the terminal 2 to provide the image of the terminal 2, an identifier is included in the request. The terminal 2 can identify the image display apparatus 1 by comparing the received identifier with an identifier stored in advance.

### 2. Hardware Configuration

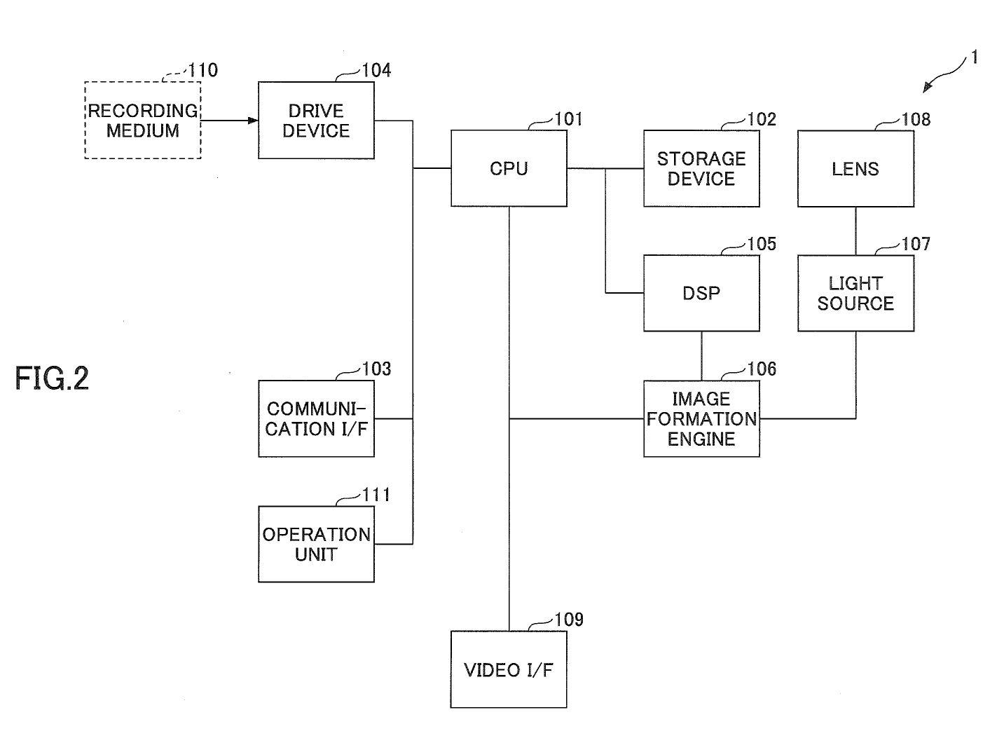

FIG. 2 illustrates an example of a hardware configuration of the image display apparatus 1.

The image display apparatus 1 includes a CPU 101, a storage device 102, a communication I/F 103, a drive device 104, a DSP 105 (Digital Signal Processor), an image formation engine 106, a light source 107, a lens 108, a video I/F 109, and an operation unit 111. The image display apparatus 1 is, for example, a projector; however, the image display apparatus 1 may be a TV monitor, etc., provided with a display instead of the light source 107 and the lens 108.

The CPU 101 performs data transfer processes with the storage device 102, the communication I/F 103, the drive device 104, the DSP 105, the image formation engine 106, and the video I/F 109. Furthermore, the CPU 101 performs processes such as data comparison. The storage device 102 stores various programs, data used by the programs, various kinds of setting information, etc. Furthermore, the storage device 102 may be used as a storage area for loading programs and a work area of the loaded programs.

The drive device 104 reads programs from a storage medium 110 recording programs realizing the first embodiment. The program read by the drive device 104 is loaded in the storage device 102. Note that the storage medium 110 is a non-transitory recording medium. Examples of the storage medium 110 are a magnetic recording medium, an optical disk, a magneto-optical disc, and a non-volatile memory.

The communication I/F 103 is connected to, for example, a wireless LAN, and performs communication with the terminal 2. The DSP 105 performs a digital signal process on the image to be displayed on the screen. The image formation engine 106 performs an image formation process based on the image that has undergone the digital signal process. The light source 107 and the lens 108 project the image that has undergone the image formation process, on a screen, etc.

The video I/F 109 is HDMI (registered trademark) (High-Definition-Multimedia-Interface) or an interface for inputting video signals. The operation unit 111 is, for example, a keyboard or a mouse, and receives various inputs from the user.

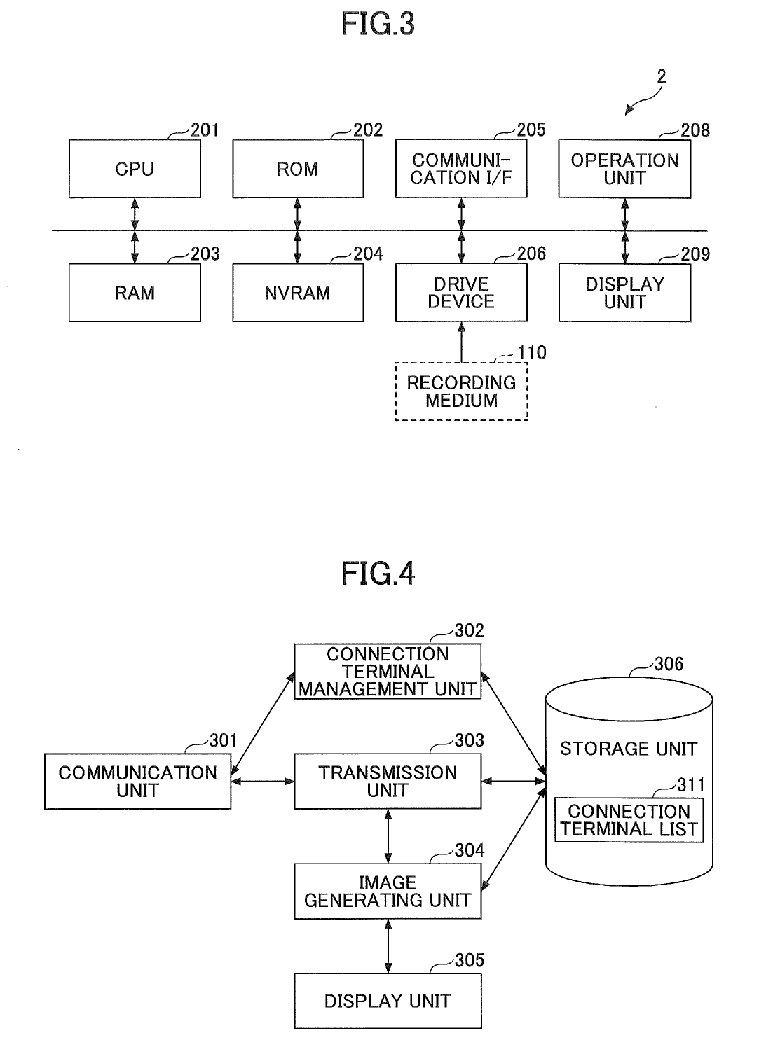

FIG. 3 illustrates an example of a hardware configuration of the terminal 2. The terminal 2 includes a CPU 201, a ROM 202, a RAM 203, a NVRAM 204, a communication I/F 205, an operation unit 208, a display unit 209, and a drive device 206. The terminal 2 is, for example, a PC (Personal Computer) or a mobile terminal such as a smartphone or a tablet terminal.

The CPU 201 performs processes of data transfer and data transmission with the ROM 202, the RAM 203, the NVRAM 204, and the communication I/F 205. The ROM 202 stores various programs and data used by the programs. The NVRAM 204 stores various kinds of setting information. The RAM 203 is used as a storage area for loading programs and a work area of the loaded programs.

The communication I/F 205 is connected to a wireless LAN, and performs communication with the image display apparatus 1. The operation unit 208 is, for example, a keyboard or a mouse, and receives various inputs from the user. The display unit 209 is, for example, a liquid crystal display or a touch panel, etc., and displays messages, etc., to the user.

The drive device 206 reads programs from the storage medium 110 reads programs from a storage medium 110 recording a program. The program read by the drive device 206 is loaded in, for example, the RAM 203, and is executed by the CPU 201.

### 3. Functions

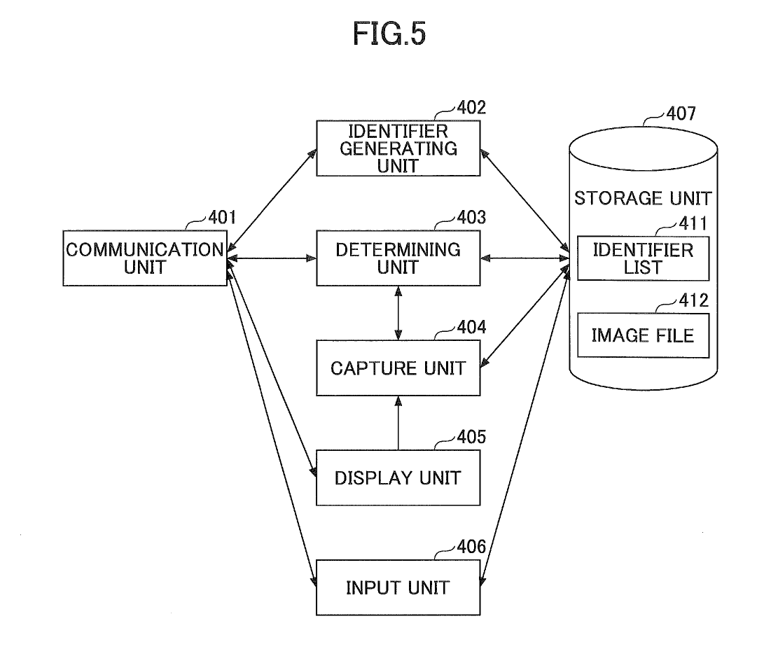

FIG. 4 illustrates an example of a functional block configuration of the image display apparatus 1 according to the first embodiment. The image display apparatus 1 includes a communication unit 301, a connection terminal management unit 302, a transmission unit 303, an image generating unit 304, a display unit 305, a storage unit 306, and a connection terminal list 311 stored in the storage unit 306.

These units may be realized by processes that the CPU 101 is caused to execute by one or more programs installed in the image display apparatus 1. Furthermore, the image display apparatus 1 uses the storage unit 306. The storage unit 306 may be realized by the storage device 102 included in the image display apparatus 1 or an external storage device connected to the image display apparatus 1 via the network 3. The storage unit 306 stores the connection terminal list 311.

The communication unit 301 performs data transfer with the terminal 2 via the communication I/F 103.

The connection terminal management unit 302 manages the terminal 2 that is the target of requesting an image, based on the connection terminal list 311.

The transmission unit 303 sends signals for requesting an image, to each terminal 2.

The image generating unit 304 generates one image, by arranging the images received from the terminals 2.

The display unit 305 displays the one image generated by the image generating unit 304, on a screen via the light source 107 and the lens 108. Note that the image is not limited to a still image; the image may be a moving image.

The connection terminal list 311 is information used for the image display apparatus 1 to recognize the terminal 2 connected to the image display apparatus 1, and the connection terminal list 311 includes the IP address of the terminal 2 connected to the image display apparatus 1 and an identifier to be sent to each terminal 2.

FIG. 5 illustrates a functional block configuration of the terminal 2 according to the first embodiment. The terminal 2 includes a communication unit 401, an identifier generating unit 402, a determining unit 403, a capture unit 404, a display unit 405, an input unit 406, a storage unit 407, an identifier list 411, and an image file 412.

These units may be realized by processes that the CPU 201 is caused to execute by one or more programs installed in the terminal 2. Furthermore, the image display apparatus 1 uses the storage unit 407. The storage unit 407 may be realized by the NVRAM 204, the RAM 203, or an external storage device connected to the image display apparatus 1 via the network 3. The storage unit 407 stores the identifier list 411 and the image file 412.

The communication unit 401 performs data transfer with the image display apparatus 1 via the communication I/F 205.

The identifier generating unit 402 generates an identifier and sends the identifier to the image display apparatus 1. Furthermore, the identifier generating unit 402 stores the identifier in the identifier list 411. Note that the identifier generating unit 402 may apply an upper limit in the number of identifiers to be stored in the identifier list 411.

The determining unit 403 searches the identifier list 411 for an identifier when the identifier is received from the image display apparatus 1, and when the identifier is included in the identifier list 411, the determining unit 403 allows the capture unit 404 to capture the screen of the terminal 2.

The capture unit 404 generates an image by capturing the screen of the terminal 2 in response to the allowance by the determining unit 403. Note that the generated image is not limited to an image obtained by capturing the screen of the terminal 2; for example, the generated image may be an image output by an application operating in the background.

The display unit 405 displays the image file 412 on a screen included in the terminal 2. The input unit 406 receives an operation of the terminal 2 from the user.

The identifier list 411 stores one or a plurality of identifiers of the image display apparatuses 1.

The image file 412 is, for example, a document file, a presentation file, a moving image file, an image file, etc. The image file 412 need not be stored in the terminal 2, but may be a moving image file received by streaming from a server, etc., connected via the network 3.

### 4. Processing procedures

### [Identifier Registration Process (Part 1)]

A description is given of process of registering the same identifier in the terminal 2 and the image display apparatus 1 in advance, before displaying the image file 412 included in the terminal 2 on the screen of the image display apparatus 1.

First, a description is given of an identifier registration process in the case of using a certificate (permit) 1102 as the identifier.

The certificate 1102 is uniquely generated for each image display apparatus 1, and is constituted by, for example, a character string obtained by combining alphabetical letters or numbers.

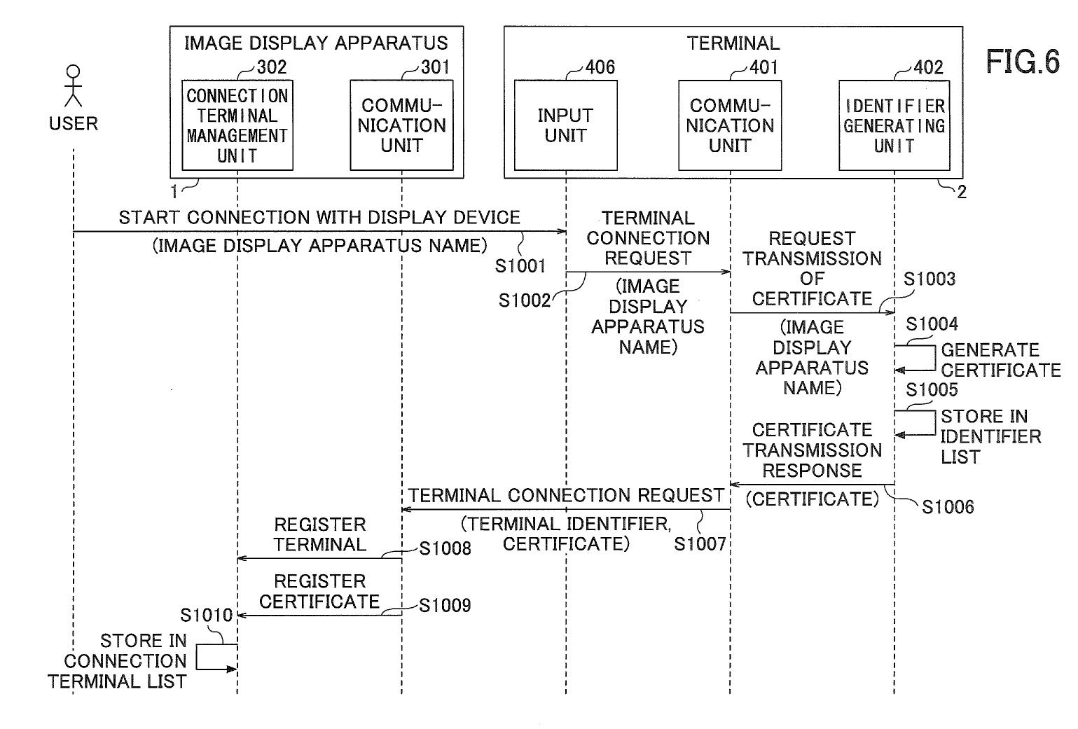

FIG. 6 is a sequence diagram illustrating an example of processing procedures for registering a certificate 1102.

The input unit 406 of the terminal 2 receives an instruction to start the connection with the image display apparatus 1, by prompting the user to input an image display apparatus name 1101 (step S1001). Next, the input unit 406 sends the input image display apparatus name 1101 to the communication unit 401 (step S1002). Here, the image display apparatus name 1101 is the name of the image display apparatus 1, and is a name that is arbitrarily set by the user.

Next, the communication unit 401 sends the image display apparatus name 1101 to the identifier generating unit 402, for generating the certificate 1102 (step S1003). The identifier generating unit 402 generates the certificate 1102 corresponding to the received image display apparatus name 1101 (step S1004), and stores the certificate 1102 in the identifier list 411 (step S1005).

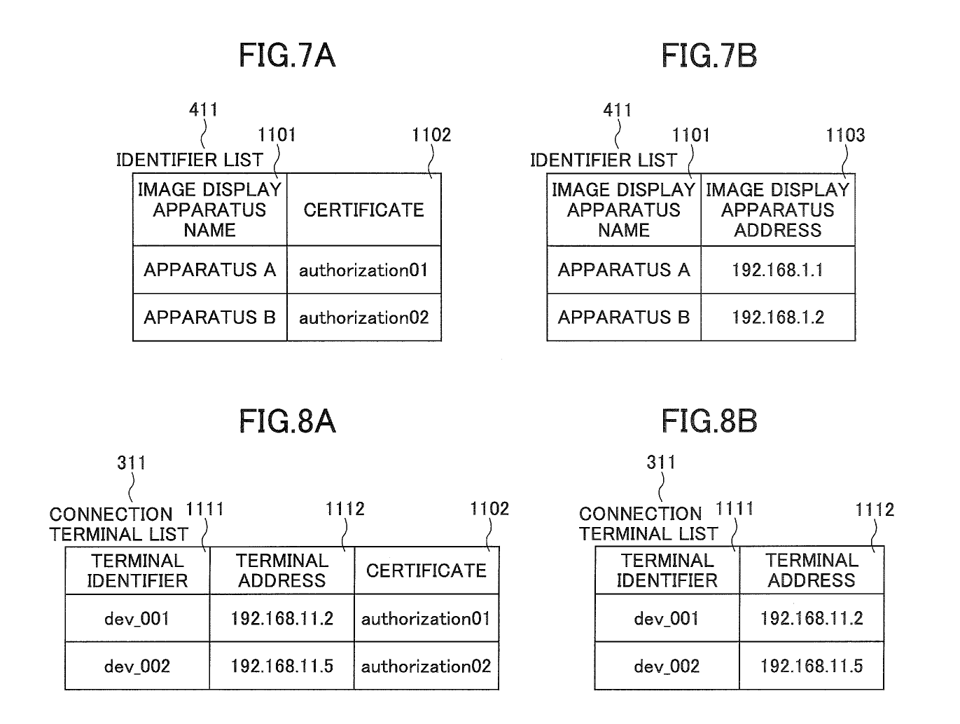

FIGS. 7A and 7B illustrate examples of an identifier list. FIG. 7A illustrates an example of an identifier list 411 in a case where the identifier is a certificate 1102. In the identifier list 411, one record is generated for each image display apparatus 1, and in each record, an image display apparatus name 1101 and a certificate 1102 corresponding to the image display apparatus name 1101 are stored.

Next, the identifier generating unit 402 sends the generated certificate 1102 to the communication unit 401 (step S1006). Next, the communication unit 401 sends a terminal connection request including a terminal identifier 1111 and the certificate 1102, to the image display apparatus 1 (step S1007).

Here, the terminal identifier 1111 is, for example, a name, etc., of the terminal 2, constituted by a character string obtained by combining alphabetical letters or numbers, and the terminal identifier 1111 is stored in the terminal 2 in advance.

When the communication unit 301 of the image display apparatus 1 receives the terminal connection request, the communication unit 301 instructs the connection terminal management unit 302 to register the terminal identifier 1111 and register the certificate 1102 (steps S1008, S1009). Next, the connection terminal management unit 302 stores the terminal identifier 1111, the certificate 1102, and a terminal address 1112 in the connection terminal list 311 (step S1010). Here, the terminal address 1112 is, for example, the IP address of the terminal 2. Note that the terminal address 1112 stored in the connection terminal list 311 may be the IP address of the terminal 2 included in the header part of the terminal connection request received by the communication unit 301.

FIGS. 8A and 8B illustrate examples of a connection terminal list 311. When the certificate 1102 is used as the identifier, the connection terminal list 311 illustrated in FIG. 8A is generated. In the connection terminal list 311, one record is generated for each terminal 2, and each record includes the terminal identifier 1111, the terminal address 1112, and the certificate 1102.

### [Image Transmission Process (Part 1)]

When the same identifier is registered in the terminal 2 and the image display apparatus 1, the image display apparatus 1 turns into a state where it is possible to request the terminal 2 to send an image.

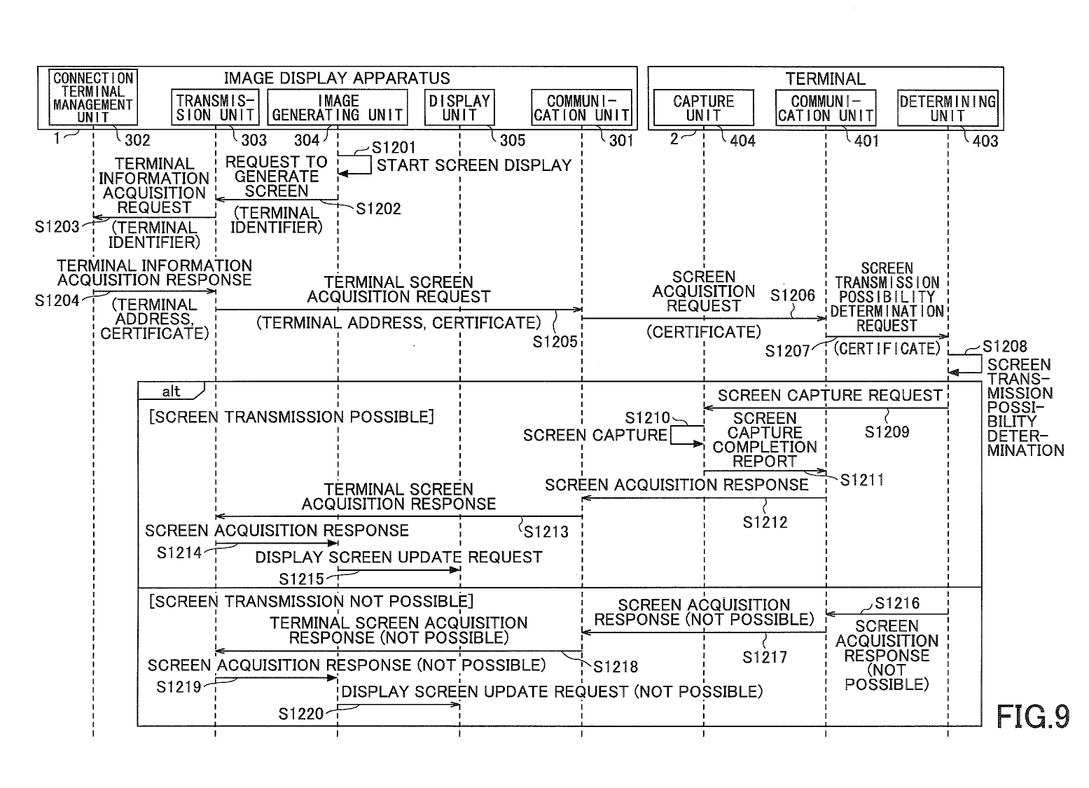

FIG. 9 is a sequence diagram illustrating an example of processing procedures for sending the screen capture of the terminal 2 to an image display apparatus 1 by using a certificate 1102. Note that in the first embodiment, four terminals 2 are connected to the image display apparatus 1 as illustrated in FIG. 1, and therefore steps S1202 through S1220 are executed in parallel for the respective terminals 2.

The image generating unit 304 of the image display apparatus 1 starts to display list screen including the images obtained by capturing the screens of the terminals 2, in one screen (step S1201). Next, the image generating unit 304 selects the terminal 2 to request the transmission of an image, and sends a screen generation request including the terminal identifier 1111 of the selected terminal 2, to the transmission unit 303 (step S1202).

Next, when the connection terminal management unit 302 receives a terminal information acquisition request including the terminal identifier 1111 from the transmission unit 303 (step S1203), the connection terminal management unit 302 searches the connection terminal list 311 for the certificate 1102 and the terminal address 1112 corresponding to the terminal identifier 1111, and sends a terminal information acquisition response including the certificate 1102 and the terminal address 1112, to the transmission unit 303 (step S1204).

Next, the transmission unit 303 sends a terminal screen acquisition request including the terminal address 1112 and the certificate 1102, to the communication unit 301 (step S1205), and the communication unit 301 sends a screen acquisition request including the certificate 1102, to the terminal 2 having the terminal address 1112 (step S1206).

The communication unit 401 of the terminal 2 receives the screen acquisition request, and sends a screen transmission possibility determination request including the certificate 1102, to the determining unit 403 (step S1207). Next, the determining unit 403 searches the identifier list 411 by using the certificate 1102 as the key, and confirms whether there is a record including the certificate 1102, in the identifier list 411 (step S1208). When there is a record including the certificate 1102, the determining unit 403 determines that it is possible to send an image obtained by capturing the screen of the terminal 2 to the image display apparatus 1, and proceeds to step S1209. Meanwhile, when there is no record including the certificate 1102, the determining unit 403 determines that it is not possible to send an image obtained by capturing the screen of the terminal 2 to the image display apparatus 1, and proceeds to step S1216.

The determining unit 403 sends a screen capture request to the capture unit 404 (step S1209), and the capture unit 404 captures a screen of the terminal 2 (step S1210). Next, the capture unit 404 sends a screen capture completion report including the captured image, to the communication unit 401 (step S1211), and the communication unit 401 sends a screen acquisition response including the captured image, to the image display apparatus 1 (step S1212).

When the communication unit 301 of the image display apparatus 1 receives the screen acquisition response, the communication unit 301 sends a terminal screen acquisition response including the captured image, to the transmission unit 303 (step S1213), and the transmission unit 303 sends the screen acquisition response to the image generating unit 304 (step S1214). Next, the image generating unit 304 sends a display screen update request including the captured image, to the display unit 305 (step S1215), and the display unit 305 updates the screen of the image display apparatus 1, and the process ends.

Next, a description is given of processing procedures of a case of determining not to send an image obtained by capturing the screen of the terminal 2 to the image display apparatus 1. The image display apparatus 1 sends a screen acquisition response (rejected) to the communication unit 401 (step S1216), and the communication unit 401 sends a screen acquisition response indicating that the captured image will not be sent, to the image display apparatus 1 (step S1217).

When the communication unit 301 of the image display apparatus 1 receives the screen acquisition response, the communication unit 301 sends a terminal screen acquisition response to the transmission unit 303 (step S1218), and the transmission unit 303 sends a screen acquisition response to the image generating unit 304 (step S1219). Next, the image generating unit 304 sends a display screen update request indicating that the captured image was not received, to the display unit 305 (step S1220), and the process ends.

### [Identifier Registration Process (Part 2)]

Next, a description is given of an identifier registration process in the case of using an IP address of the image display apparatus 1 (hereinafter, “image display apparatus address 1103”) as the identifier.

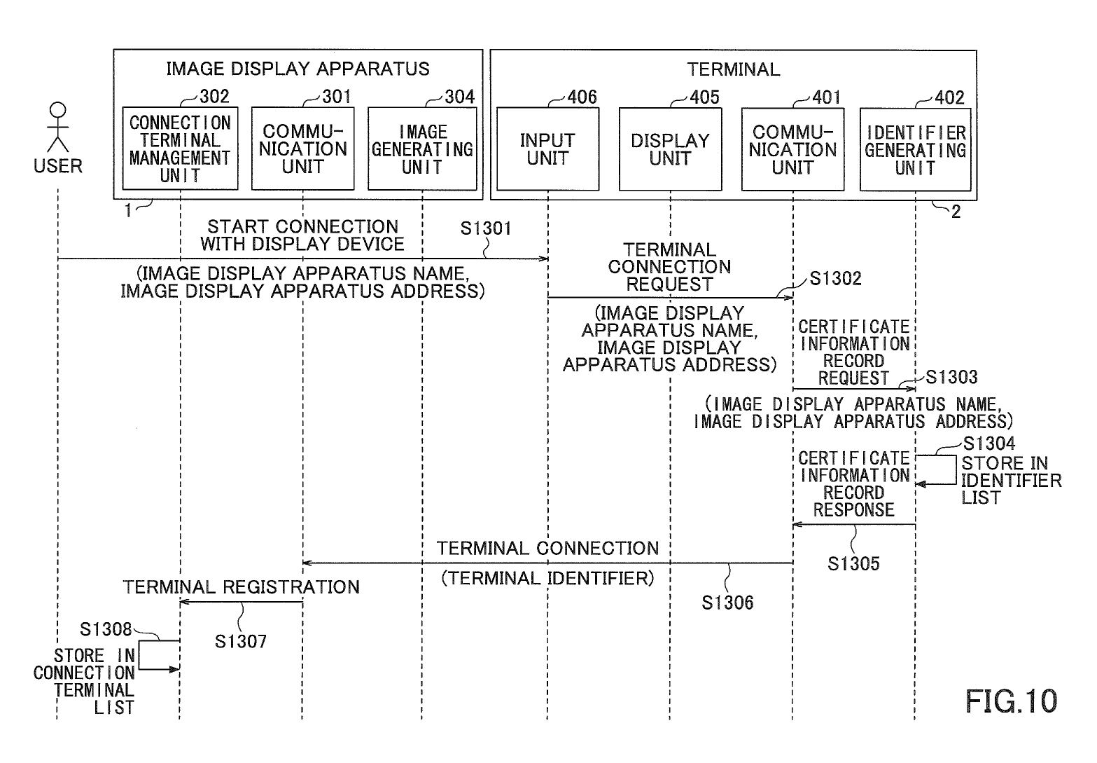

FIG. 10 is a sequence diagram illustrating an example of processing procedures for registering the image display apparatus address.

The input unit 406 of the terminal 2 receives an instruction to start the connection with the image display apparatus 1, by prompting the user to input the image display apparatus name 1101 and the image display apparatus address 1103 (step S1301). Next, the input unit 406 sends the input image display apparatus name 1101 and the image display apparatus address 1103 to the communication unit 401 (step S1302).

Next, the communication unit 401 sends the image display apparatus name 1101 and the image display apparatus address 1103 to the identifier generating unit 402, for generating the certificate 1102 (step S1303). The identifier generating unit 402 generates the certificate 1102 corresponding to the received image display apparatus name 1101 (step S1304), and stores the certificate 1102 in the identifier list 411 (step S1305).

FIG. 7B illustrates an example of an identifier list 411 in a case where the identifier is an image display apparatus address 1103. In the identifier list 411, one record is generated for each image display apparatus 1, and in each record, an image display apparatus name 1101 and an image display apparatus address 1103 corresponding to the image display apparatus name 1101 are stored.

Next, the identifier generating unit 402 sends a report that the image display apparatus name 1101 and the image display apparatus address 1103 have been stored in the identifier list 411, to the communication unit 401 (step S1305). Next, the communication unit 401 sends a terminal connection request including a terminal identifier 1111 that is stored in the terminal 2 in advance, to the image display apparatus 1 (step S1306).

When the communication unit 301 of the image display apparatus 1 receives the terminal connection request, the communication unit 301 instructs the connection terminal management unit 302 to register the terminal identifier 1111 (step S1307), and the connection terminal management unit 302 stores the terminal identifier 1111 and the terminal address 1112 in the connection terminal list 311 (step S1308).

FIG. BE illustrates an example of a connection terminal list 311 that is generated when the image display apparatus address is used as the identifier. In the connection terminal list 311, one record is generated for each terminal 2, and a terminal identifier 1111 and a terminal address 1112 is stored in each record.

### [Image Transmission Process (Part 2)]

Next, a description is given of an image transmission process in a case where the IP address of the image display apparatus 1 is used as the identifier.

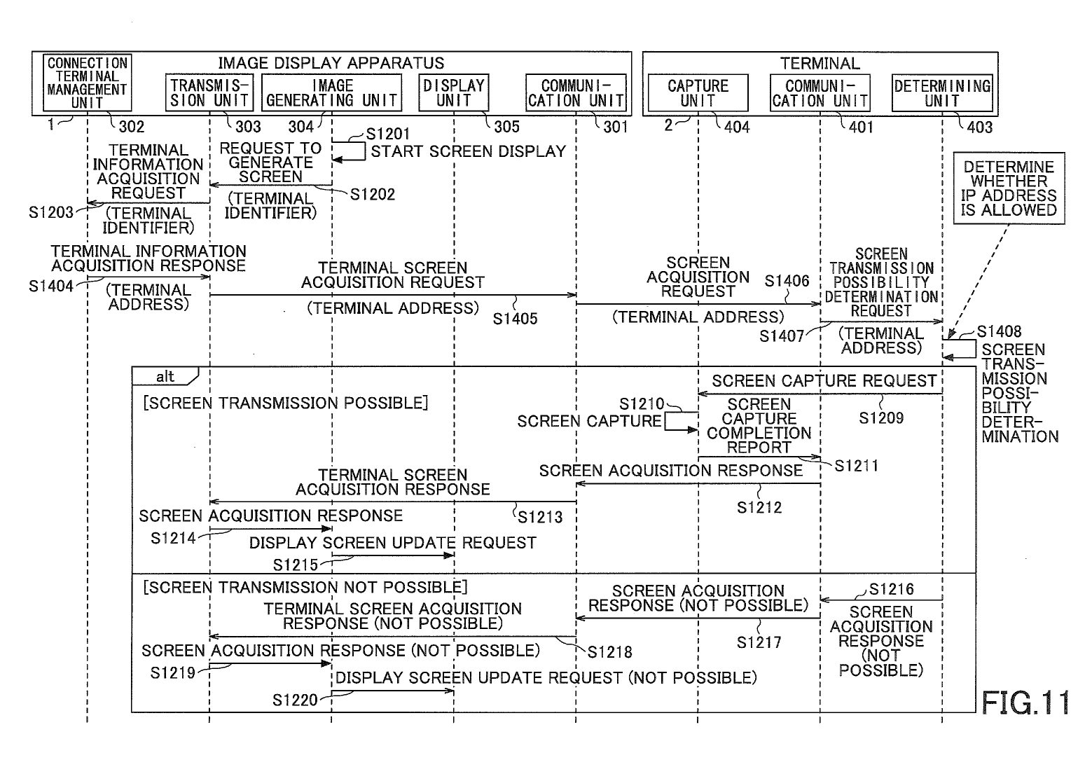

FIG. 11 is a sequence diagram illustrating an example of processing procedures for sending the screen capture of the terminal 2 to an image display apparatus 1 by using an image display apparatus address. Note that in the first embodiment, four terminals 2 are connected to the image display apparatus 1 as illustrated in FIG. 1, and therefore the processing procedures are executed in parallel for the respective terminals 2.

Steps S1201 through S1203 are the same as those of FIG. 9, and therefore descriptions thereof are omitted. When the connection terminal management unit 302 receives the terminal identifier 1111 included in the terminal information acquisition request received from the transmission unit 303, the connection terminal management unit 302 searches the connection terminal list 311 for the terminal address 1112 corresponding to the terminal identifier 1111, and sends a terminal information acquisition response including the terminal address 1112, to the transmission unit 303 (step S1404).

Next, the transmission unit 303 sends a terminal screen acquisition request including the terminal address 1112, to the communication unit 301 (step S1405). The communication unit 301 sends a screen acquisition request including the terminal address 1112, to the terminal 2 having the terminal address 1112 (step S1406).

The communication unit 401 of the terminal 2 receives the screen acquisition request, and sends a screen transmission possibility determination request including the terminal address 1112, to the determining unit 403 (step S1407). Next, the determining unit 403 searches the identifier list 411 by using the terminal address 1112 as the key, and confirms whether there is a record including terminal address 1112, in the identifier list 411 (step S1408). When there is a record including the terminal address 1112, the determining unit 403 determines that it is possible to send an image obtained by capturing the screen of the terminal 2 to the image display apparatus 1, and proceeds to step S1209. Meanwhile, when there is no record including the certificate 1102, the determining unit 403 determines that it is not possible to send an image obtained by capturing the screen of the terminal 2 to the image display apparatus 1, and proceeds to step S1216. The processing procedures of steps S1209 through S1220 are the same as those of FIG. 9, and therefore descriptions thereof are omitted.

### [Modified Example 1 of Screen Transmission Possibility Determination]

A description is given of a modified example of the screen transmission possibility determination by the determining unit 403, described in step S1208 of FIG. 9 and step S1408 of FIG. 11.

First, as a modified example 1, a description is given of processing procedures of the screen transmission possibility determination, in a case where the number of times (frequency) of sending a captured image to the image display apparatus 1, is restricted to a certain number of times (frequency). Note that a description is given of a case of using the certificate 1102 as the identifier, however, the screen transmission possibility determination of the modified example 1 is also applicable of a case of using the image display apparatus address 1103 as the identifier.

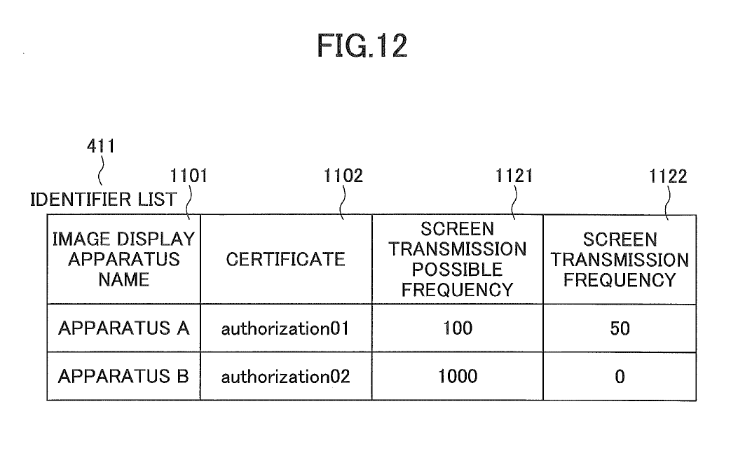

FIG. 12 illustrates an example of an identifier list used in the screen transmission possibility determination process (modified example 1). The identifier list 411 according to the modified example 1 includes an image display apparatus name 1101, a certificate 1102, a screen transmission possible frequency 1121, and a screen transmission frequency 1122.

The screen transmission possible frequency 1121 is the upper limit value of the number of times it is possible to send an image obtained by capturing the screen of the terminal 2, to the image display apparatus 1. For example, the screen transmission possible frequency 1121 may be set for each image display apparatus 1, or the same screen transmission possible frequency 1121 may be set for all of the image display apparatuses 1. Furthermore, as the screen transmission possible frequency 1121, a user may set an arbitrary frequency, or a predetermined fixed value may be set.

The screen transmission frequency 1122 is the number of times an image obtained by capturing the screen of the terminal 2 is sent to the image display apparatus 1, and the screen transmission frequency 1122 is incremented every time the image is sent.

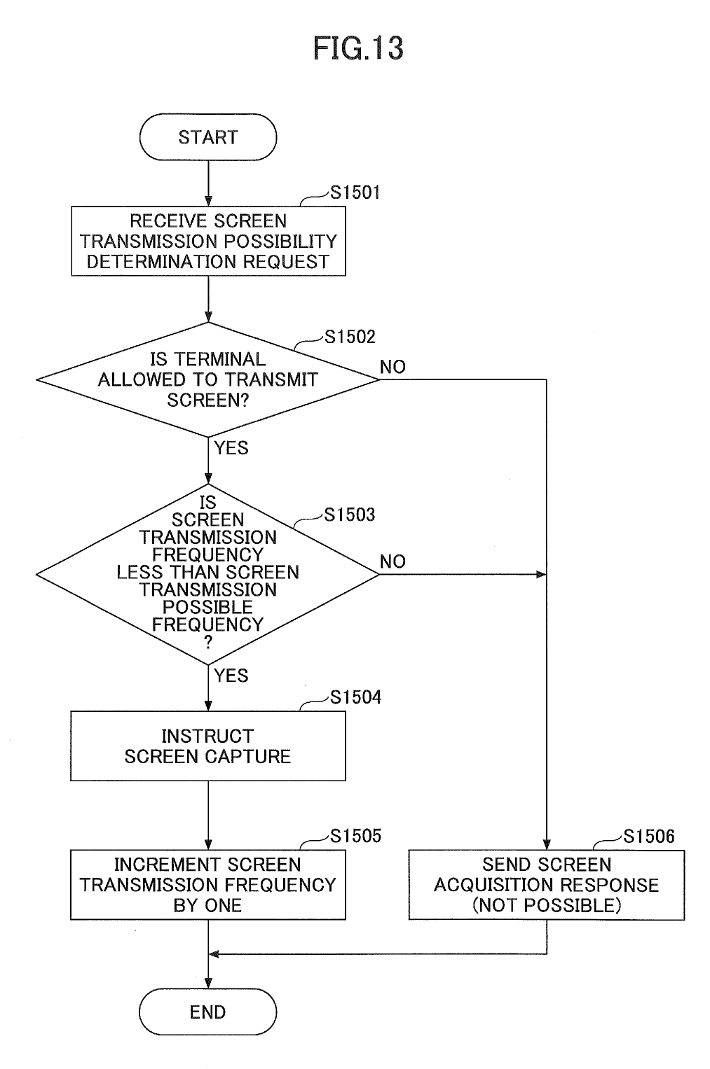

FIG. 13 is a flowchart of an example of processing procedures of the screen transmission possibility determination process (modified example 1).

When the determining unit 403 receives a screen transmission possibility determination request including the certificate 1102 from the communication unit 401 (step S1501), the determining unit 403 searches the identifier list 411 by using the certificate 1102 as the key, and confirms whether there is a record including the certificate 1102 in the identifier list 411 (step S1502). When there is a record including the certificate 1102, the process proceeds to step S1503. Meanwhile, when there is no record including the certificate 1102, the process proceeds to step S1506.

Next, the determining unit 403 acquires the screen transmission possible frequency 1121 and the screen transmission frequency 1122 from the record including the certificate 1102, and confirms whether the screen transmission frequency 1122 is less than the screen transmission possible frequency 1121 (step S1503). When the screen transmission frequency 1122 is less than the screen transmission possible frequency 1121, the process proceeds to the processing procedure of step S1504, and when the screen transmission frequency 1122 is greater than or equal to the screen transmission possible frequency 1121, the process proceeds to step S1506.

The determining unit 403 sends a screen capture request to the capture unit 404 (step S1504), and increments the screen transmission frequency 1122 in the identifier list 411 (step S1505).

In step S1506, the determining unit 403 sends a screen acquisition response (rejected) to the communication unit 401 (step S1216 in FIG. 9 or FIG. 11). Note that the processing procedure of step S1504 is the same as step S1209 in FIG. 9, and the processing procedure of step S1506 is the same as step S1216 in FIG. 9.

As described above in the modified example 1 of the screen transmission possibility determination, by preventing the capturing of the screen of the terminal 2 from being performed more than necessary from the image display apparatus 1, it is possible to alleviate the processing load of the terminal 2, and it is possible to alleviate information leakage caused by unauthorized capturing of a screen.

### [Modified Example 2 of Screen Transmission Possibility Determination]

Next, as a modified example 2, a description is given of processing procedures of the screen transmission possibility determination, in a case where it is possible to send an image obtained by capturing the screen of the terminal 2 only within a certain time period from the first time when an image obtained by capturing the screen of the terminal 2 has been sent to the image display apparatus 1. Note that a description is given of a case of using the certificate 1102 as the identifier; however, the screen transmission possibility determination of the modified example 2 is also applicable of a case of using the image display apparatus address 1103 as the identifier.

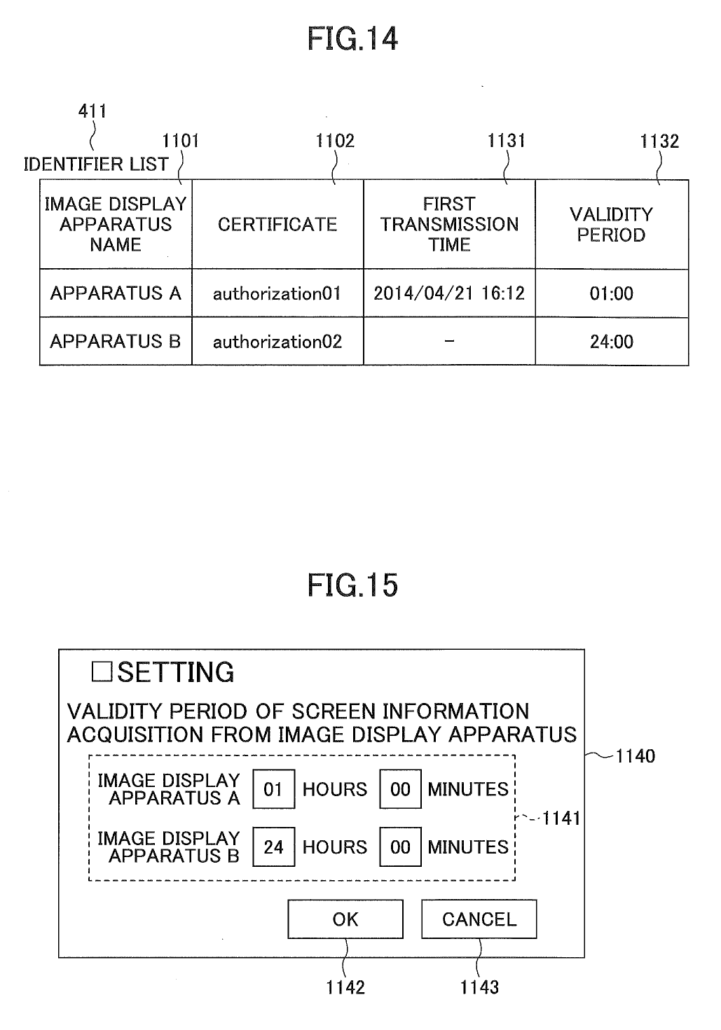

FIG. 14 illustrates an example of an identifier list used in the screen transmission possibility determination process (modified example 2). The identifier list 411 according to the modified example 2 includes an image display apparatus name 1101, a certificate 1102, a first transmission time 1131, and a validity period 1132.

The first transmission time 1131 is the time and date of the first time when an image obtained by capturing the screen of the terminal 2 has been sent to the image display apparatus 1, and a first transmission time 1131 is stored in each image display apparatus 1. Note that when the terminal 2 has not sent an image obtained by capturing the screen of the terminal 2 to the image display apparatus 1, for example, “-” is set, which indicates that the first transmission time 1131 is not set.

The validity period 1132 is the period during which it is possible to send an image obtained by capturing the screen of the terminal 2, to the image display apparatus 1. In the case of the modified example 2, the validity period 1132 is a period that uses the first transmission time 1131 as a standard. Specifically, when 2014/04/21 16:12 is set in the first transmission time 1131, and the validity period 1132 is 01:00, it is possible for the terminal 2 to send an image obtained by capturing the screen of the terminal 2 to the image display apparatus 1 until 2014/04/21 17:12; however, when this time has passed, the terminal 2 does not send an image obtained by capturing the screen of the terminal 2 to the image display apparatus 1.

FIG. 15 illustrates an example of a validity period setting screen. A setting screen 1140 of the validity period 1132 is a screen that is displayed on the display unit 209 of the terminal 2, and includes a box 1141 for prompting input of the validity period 1132 of each image display apparatus 1, an OK button 1142, and a cancel button 1143. The time input in the box 1141 is registered as the validity period 1132 in the identifier list 411, when the OK button 1142 is pressed.

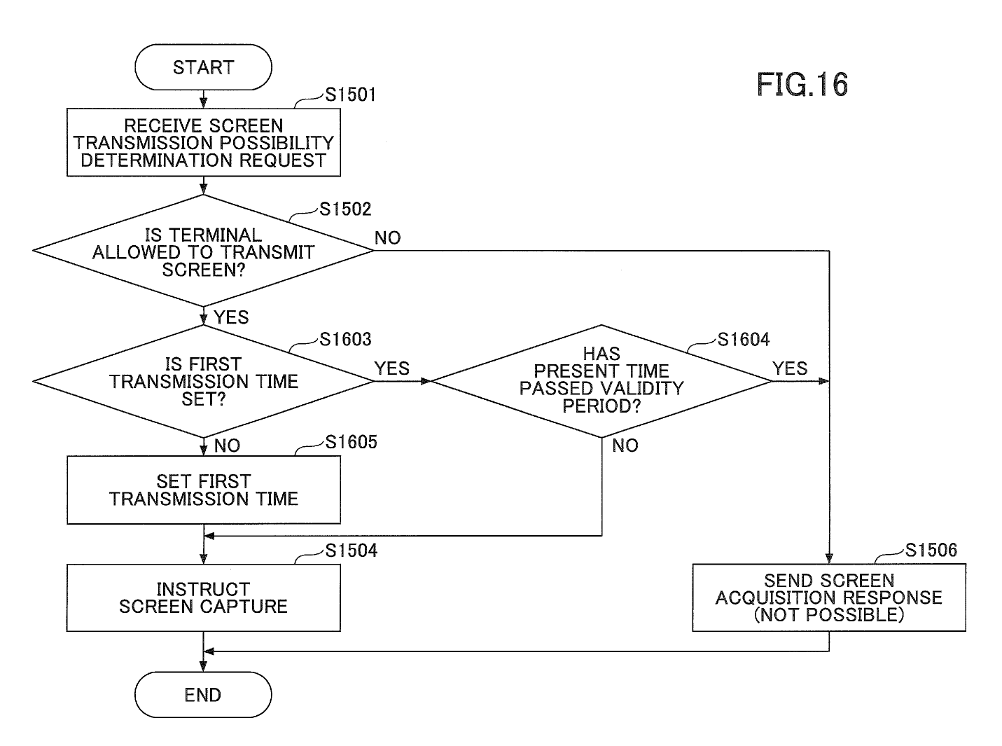

FIG. 16 is as flowchart of an example of processing procedures of the screen transmission possibility determination process (modified example 2). The processing procedures of step S1501, step S1502, step S1504, and step S1506 are the same as those of FIG. 13, and therefore descriptions thereof are omitted.

The determining unit 403 confirms whether a first transmission time 1131 is set in the record including the certificate 1102 (step S1603). When the first transmission time 1131 is set, the process proceeds to step S1604. When the first transmission time 1131 is not set, the process proceeds to step S1605.

In step S1604, the determining unit 403 calculates the time (transmission possible time) until which it is possible to send an image obtained by capturing the screen, from the first transmission time 1131 and the validity period 1132, and compares the calculated time with the present time. When the present time is the same as the transmission possible time or the present time has not passed the transmission possible time, the process proceeds to the processing procedure of step S1504. When the present time has passed the transmission possible time, the process proceeds to the processing procedure of step S1506.

As described above in the modified example 2 of the screen transmission possibility determination, by preventing the capturing of the screen of the terminal 2 from being performed more than necessary from the image display apparatus 1, it is possible to alleviate the processing load of the terminal 2, and it is possible to alleviate information leakage caused by unauthorized capturing of a screen.

### [Modified Example 3 of Screen Transmission Possibility Determination]

Next, as a modified example 3, a description is given of processing procedures of the screen transmission possibility determination, in a case where it is possible to send an image obtained by capturing the screen of the terminal 2 only within a certain time period from the last time when an image obtained by capturing the screen of the terminal 2 has been sent to the image display apparatus 1. Note that a description is given of a case of using the certificate 1102 as the identifier, however, the screen transmission possibility determination of the modified example 3 is also applicable of a case of using the image display apparatus address 1103 as the identifier.

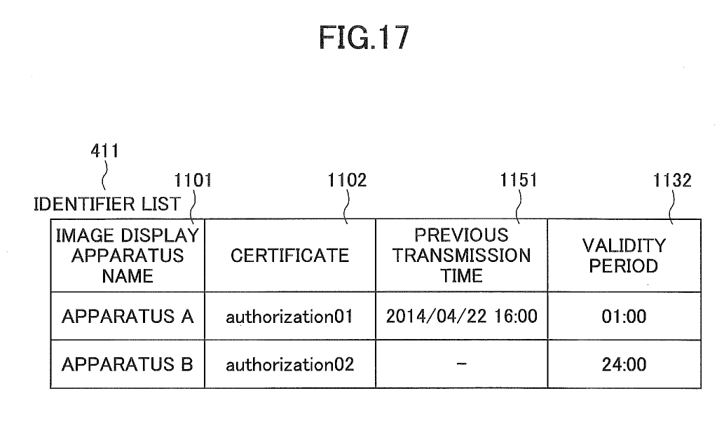

FIG. 17 illustrates an example of an identifier list used in the screen transmission possibility determination process (modified example 3). The identifier list 411 according to the modified example 3 includes an image display apparatus name 1101, a certificate 1102, a previous transmission time 1151, and a validity period 1132.

The previous transmission time 1151 is the time and date of the last time when an image obtained by capturing the screen of the terminal 2 has been sent to the image display apparatus 1, and a previous transmission time 1151 is stored in each image display apparatus 1. Note that when the terminal 2 has not sent an image obtained by capturing the screen of the terminal 2 to the image display apparatus 1, for example, “-” is set, which indicates that the previous transmission time 1151 is not set.

The validity period 1132 is the same that in FIG. 14; however, in the modified example 3, the validity period 1132 is a period that uses the previous transmission time 1151 as a standard.

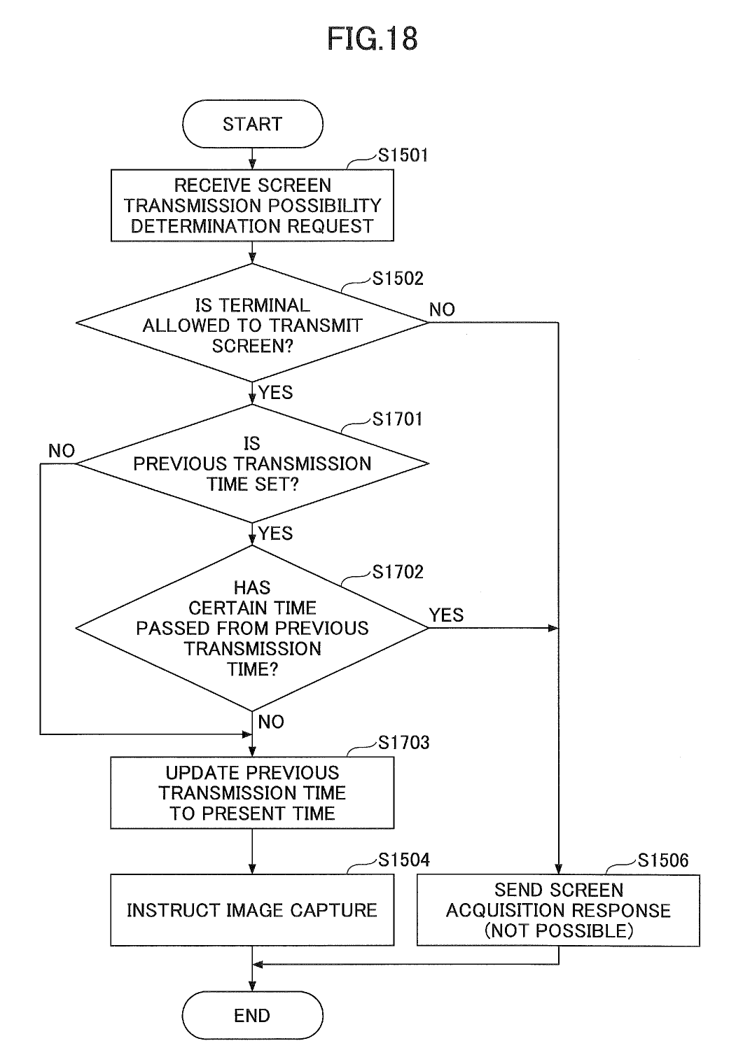

FIG. 18 is as flowchart of an example of processing procedures of the screen transmission possibility determination process (modified example 3). The processing procedures of step S1501, step S1502, step S1504, and step S1506 are the same as those of FIG. 13, and therefore descriptions thereof are omitted.

The determining unit 403 confirms whether a previous transmission time 1151 is set in the record including the certificate 1102 (step S1701). When the previous transmission time 1151 is set, the process proceeds to step S1702. When the previous transmission time 1151 is not set, the process proceeds to step S1703.

In step S1702, the determining unit 403 determines whether the validity period 1132 has passed from the previous transmission time 1151, by comparing the previous transmission time 1151 and the validity period 1132 with the present time. When the validity period 1132 has not passed from the previous transmission time 1151, the process proceeds to the processing procedure of step S1703, and when the validity period 1132 has passed, the process proceeds to the processing procedure of step S1506.

In step S1703, the determining unit 403 updates the previous transmission time 1151 to the present time.

As described above in the modified example 3 of the screen transmission possibility determination, by preventing the capturing of the screen of the terminal 2 from being performed more than necessary from the image display apparatus 1, it is possible to alleviate the processing load of the terminal 2, and it is possible to alleviate information leakage caused by unauthorized capturing of a screen.

### [Modified Example 1 of Identifier Registration Process]

A description is given of a modified example of the process of storing an identifier in the identifier list 411 by the identifier generating unit 402, described with reference to step S1005 of FIG. 6 and step S1304 of FIG. 10.

First, as the modified example 1, a description is given of processing procedures in a case where an upper limit number of identifiers that can be stored in the identifier list 411 is set in advance, and when registering the identifier, it is possible to register the identifier when the upper limit number is not exceeded.

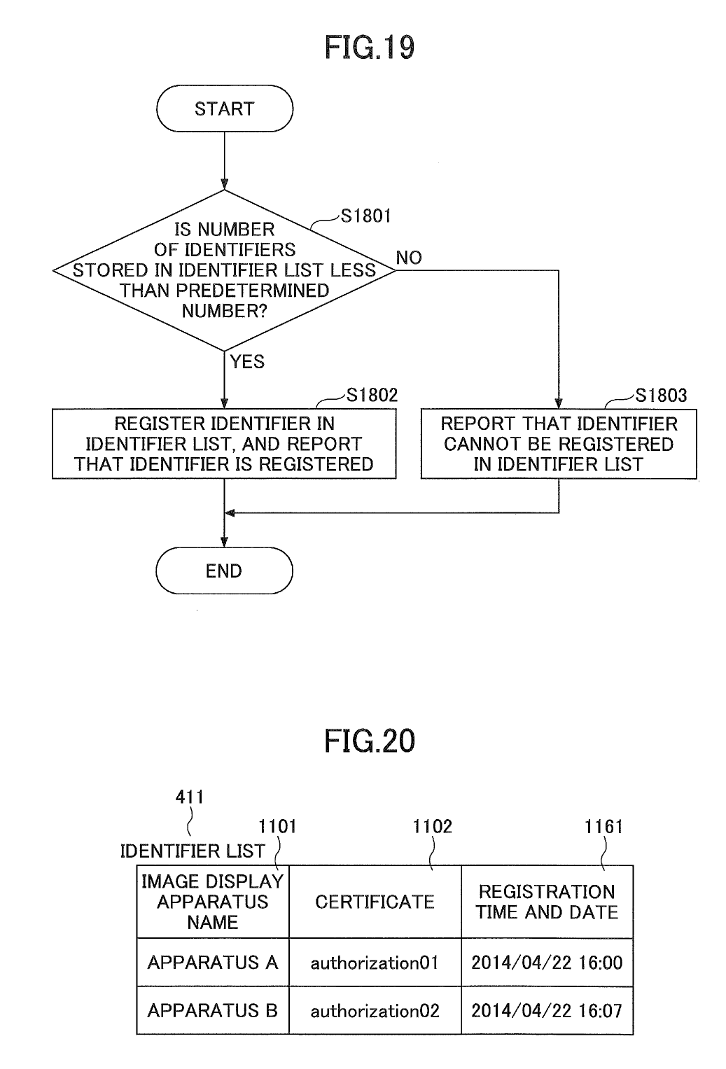

FIG. 19 illustrates an example of processing procedures of the identifier registration process (modified example 1). First, the identifier generating unit 402 confirms whether the number of identifiers registered in the identifier list 411 is less than an upper limit number that is set in advance. When the number of identifiers registered in the identifier list 411 is less than an upper limit number that is set in advance, the process proceeds to step S1802. When the number of identifiers registered in the identifier list 411 is the upper limit number that is set in advance, the process proceeds to step S1803.

In step S1802, the identifier generating unit 402 sends, to the communication unit 401, a certificate transmission response (step S1006 of FIG. 6) indicating that an identifier has been registered in the identifier list 411.

In step S1803, the identifier generating unit 402 sends, to the communication unit 401, a certificate transmission response (step S1006 of FIG. 6) indicating that an identifier cannot be registered in the identifier list 411.

### [Modified Example 2 of Identifier Registration Process]

Next, as the modified example 2, a description is given of processing procedures in a case where, when registering a new identifier, when the number of stored identifiers has reached the upper limit number defined in advance, the identifier having the oldest registration time and date 1161 is deleted, and the new identifier is registered. Note that a description is given of a case of using the certificate 1102 as the identifier, however, the identifier registration process of the modified example 2 is also applicable of a case of using the image display apparatus address 1103 as the identifier.

FIG. 20 illustrates an example of an identifier list 411 used in the identifier registration process (modified example 2). The identifier list 411 includes the image display apparatus name 1101, the certificate 1102, and the registration time and date 1161.

The registration time and date 1161 is the time and date when the identifier is registered in the identifier list 411.

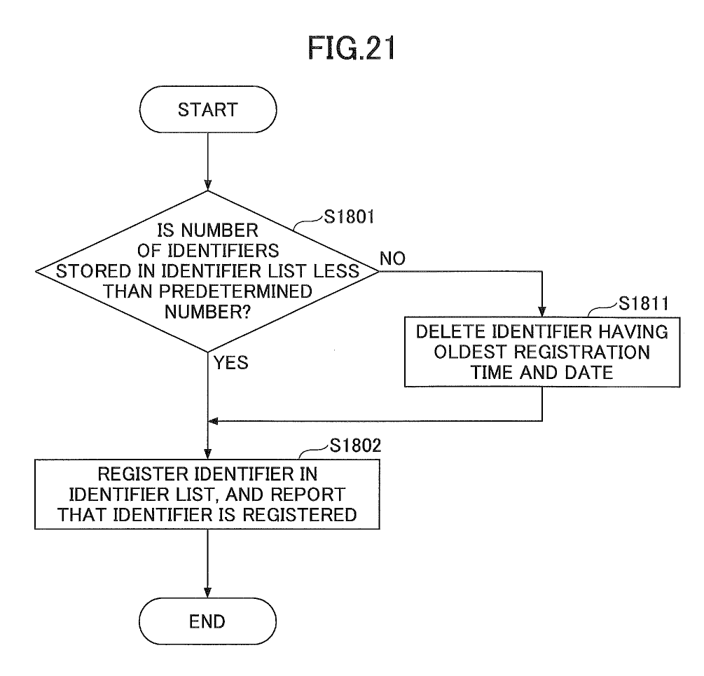

FIG. 21 illustrates an example of processing procedures of the identifier registration process (modified example 2). Step S1801 and step S1802 are the same as those of FIG. 19, and therefore descriptions thereof are omitted.

In step S1811, when the number of identifiers stored in the identifier list 411 has reached the upper limit number that is defined in advance, the identifier generating unit 402 searches the identifier list 411 for the record including the oldest registration time and date 1161, and deletes the search-found record. By deleting the record, the identifier having the oldest registration time and date 1161 is deleted from the identifier list 411.

### [Registration Release Process]

A description is given of processing procedures of releasing the registration state between the terminal 2 and the image display apparatus 1 according to an instruction by the user, in a state where the registration process of the identifier between the terminal 2 and the image display apparatus 1 has been completed, and there is no more need to display the screen of the terminal 2 on the image display apparatus 1.

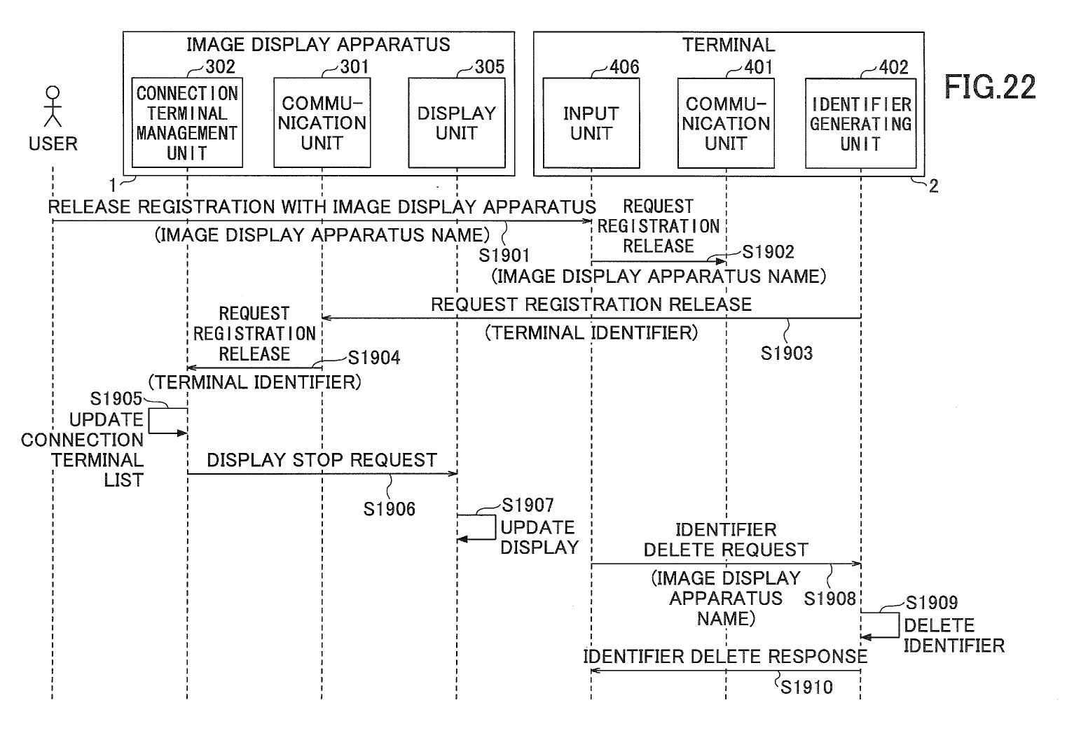

FIG. 22 illustrates an example of processing procedures of the registration release process. FIG. 22 illustrates the processing procedures in a case where the image display apparatus 1 is displaying, on a screen, an image obtained by capturing the screen of the terminal 2, and the processing procedures are performed from when the registration state between the terminal 2 and the image display apparatus 1 is released upon receiving an instruction from the user, to when the image displayed on the screen by the image display apparatus 1 is erased as a result of the release.

According to an operation by the user, an instruction is given to the terminal 2 to release the registration with the specified image display apparatus 1 (step S1901). Next, the input unit 406 of the terminal 2 sends a registration release request including the image display apparatus name 1101 to the communication unit 401 (step S1902), and the communication unit 401 sends the registration release request including the terminal identifier 1111, to the specified image display apparatus 1 (step S1903).

The communication unit 301 of the image display apparatus 1 sends the registration release request including the terminal identifier 1111 to the connection terminal management unit 302 (step S1904), and the connection terminal management unit 302 updates the connection terminal list 311 by deleting the record including the received terminal identifier 1111, from the connection terminal list 311. That is, the received terminal identifier 1111, the terminal address 1112 and the certificate 1102 corresponding to the received terminal identifier 1111, are deleted from the connection terminal list 311 (step S1905). Next, the connection terminal management unit 302 instructs the display unit 305 to erase the image displayed on the screen (step S1906), and the display unit 305 that has received the instruction updates the display (step S1907).

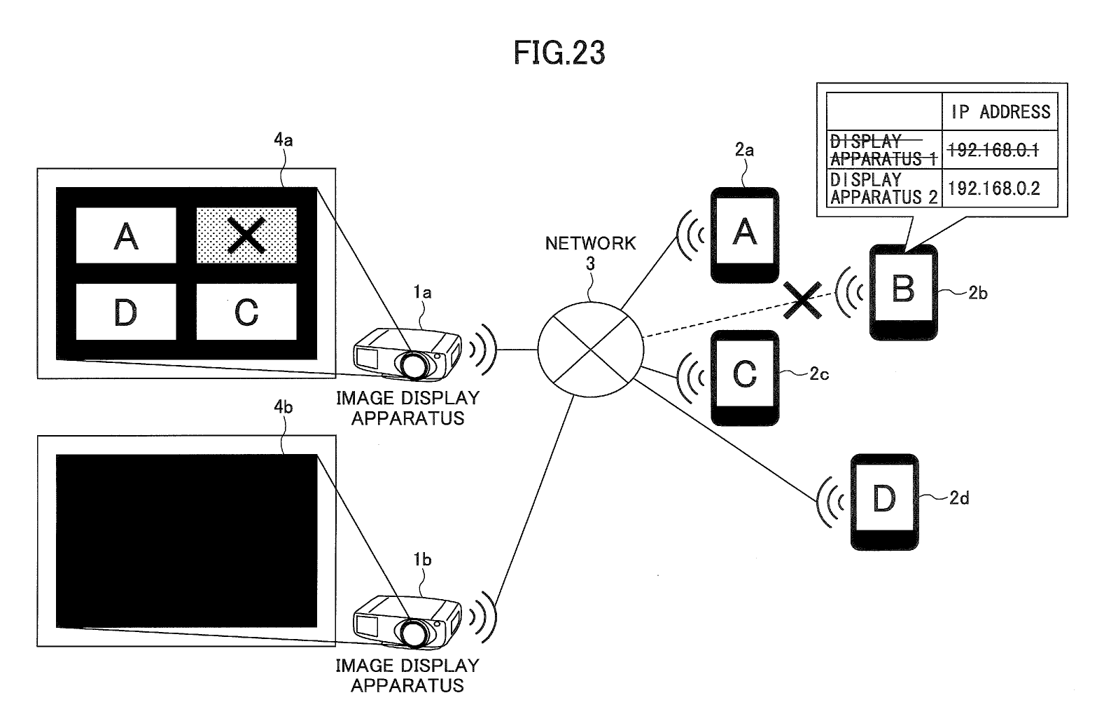

FIG. 23 illustrates an example of a display screen in a case where the registration state has been released. When a user instructs registration release with the image display apparatus 1 from the terminal 2b, in a display area 4a of the image display apparatus 1, the screen of the terminal 2b is erased.

Furthermore, the input unit 406 of the terminal 2 performs the process of step S1908 in parallel with the process of step S1902.

In step S1908, the input unit 406 of the terminal 2 sends, to the identifier generating unit 402, an identifier delete request including the image display apparatus name 1101 specified in step S1901. Next, the identifier generating unit 402 deletes the record including the image display apparatus name 1101 from the identifier list 411 (step S1909), and sends, to the input unit 406, an identifier delete response indicating that the deletion of the identifier has been completed (step S1910), and the process ends.

According to the first embodiment described above, in an image display system in which the image display apparatus 1 acquires the screens of a plurality of terminals 2 via the network 3, the terminal 2 can identify the image display apparatus 1 by simple communication between the terminal 2 and the image display apparatus 1, and therefore the security is easily enhanced without the need for the user to separately perform time-consuming operations for authentication.

Note that in the first embodiment, the certificate 1102 or the image display apparatus address 1103 is an example of an identifier. Furthermore, the transmission unit 303 is an example of a first sending unit. Furthermore, the capture unit 404 is an example of a second sending unit. Furthermore, the display unit 305 is an example of a first display unit. Furthermore, the storage unit 306 is an example of a first storage unit. Furthermore, the storage unit 407 is an example of a second storage unit. Furthermore, the display unit 405 is an example of a second display unit. Furthermore, an image obtained by capturing the screen of the terminal 2 is an example of a content.

### Second Embodiment

Next, a description is given of a second embodiment with reference to drawings.

Note that descriptions of the same elements as those of the first embodiment are omitted. Furthermore, the points that are not particularly mentioned may be the same as those of the first embodiment.

### (1. Overview)

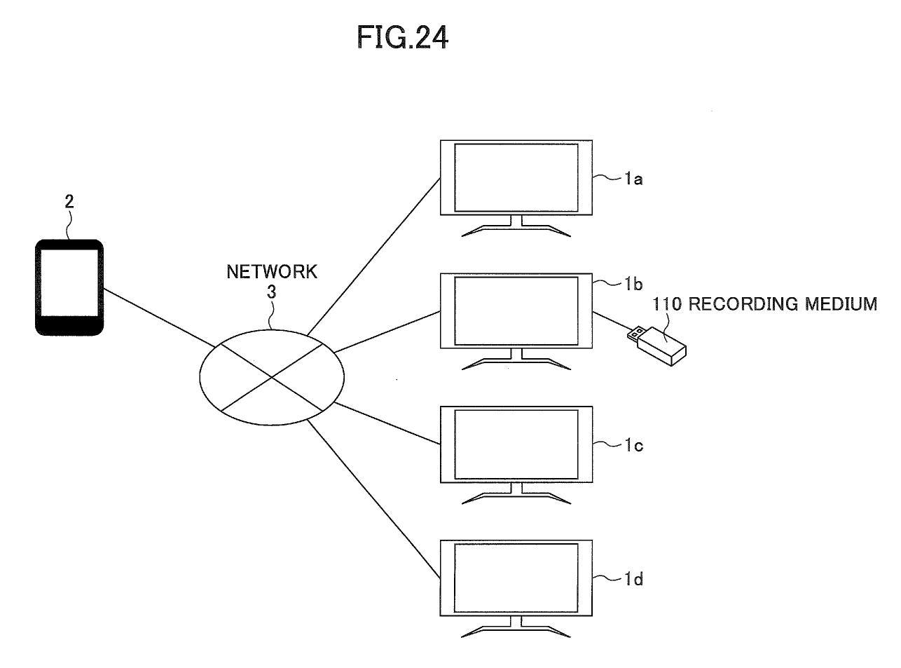

FIG. 24 illustrates an example of a network configuration of an image display system according to the second embodiment. Image display apparatuses 1a, 1b, 1c, and 1d and a terminal 2 are connected via a network 3. The image display system according to the second embodiment includes four image display apparatuses 1 and one terminal 2; however, there may be one through three or five or more image display apparatuses 1 and two or more terminals 2.

The image display apparatus 1 displays an image received from each terminal 2 or an image stored in the storage medium 110, on a monitor screen or a screen formed by radiating light of a light source toward a screen.

The terminal 2 displays, on the screen of the terminal 2, a content 612 stored in the terminal 2 itself or a content 612 acquired via the network 3 such as the Internet, and also sends an image displayed on the screen of the terminal 2 to the image display apparatus 1.

Here, a description is given of the background of the image display system according to the second embodiment.

According to the ease of connection in a wireless manner, a system in which the terminal 2 and the image display apparatus 1 are connected by a network 3, and the screen of the terminal 2 is displayed on the image display apparatus 1, is becoming popular in the world. In the conventional network connection type image display apparatus 1, in order to identify the image display apparatus 1 that is the connection target from the terminal 2, identification information such as the IP address or an image display apparatus name 2601 of the image display apparatus 1 is displayed on the terminal 2, such that the terminal 2 can identify the image display apparatus 1 that is the connection target. However, in an environment in which a plurality of image display apparatuses 1 are connected in the same network, with only the identification information such as the IP address and the image display apparatus name 2601, the user may erroneously connect the terminal 2 to the incorrect image display apparatus 1.

In order to address such a problem, one approach may be to display a test image, etc., on the image display apparatus 1 from the terminal 2, so that the user can confirm whether the terminal 2 is being connected to the correct image display apparatus 1.

However, when the image display apparatus 1 that is the connection target is being used (that is, when the image display apparatus 1 is displaying an image sent from another terminal 2 or an image of an external storage medium), the usage of the image display apparatus 1 needs to be temporarily stopped.

Accordingly, in the image display system according to the second embodiment, screen shots of screens of the image display apparatuses 1 that have been found by network search are acquired, and the acquired screen shots are displayed on a list on the screen of the terminal 2. Accordingly, even when the image display apparatus 1 is being used, it is possible to reduce the possibility of the user connecting the terminal 2 to the wrong image display apparatus 1.

### (2. Hardware Configuration)

The hardware configurations of the image display apparatus 1 and the terminal 2 according to the second embodiment are the same as those of FIGS. 2 and 3, respectively, and therefore descriptions thereof are omitted.

### (3. Functions)

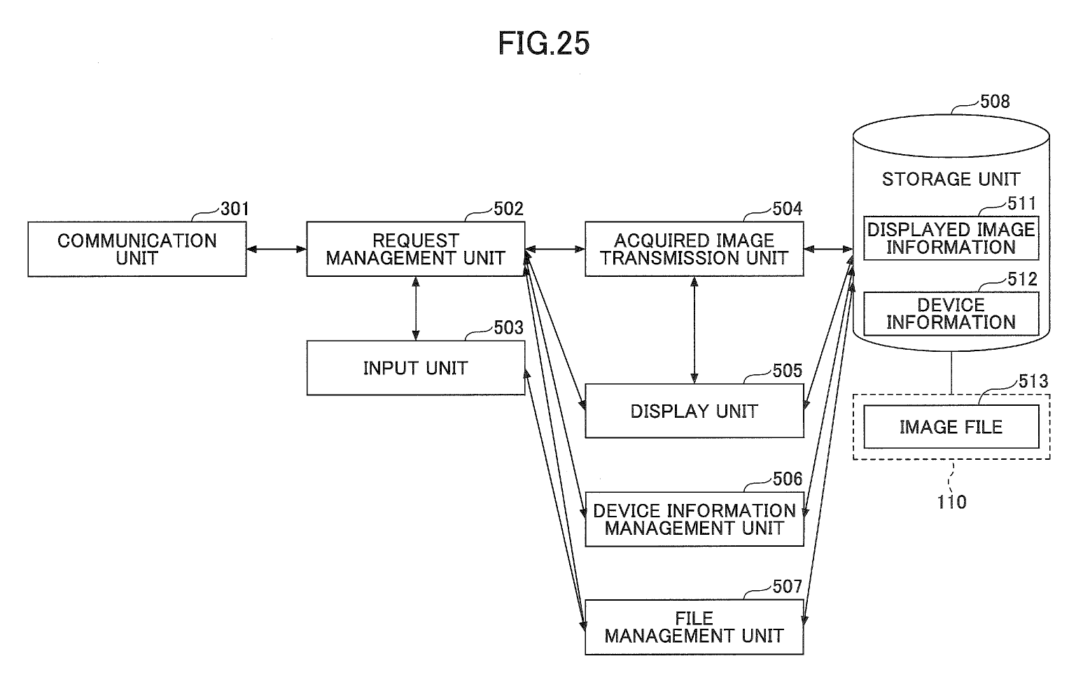

FIG. 25 illustrates an example of a functional block configuration of the image display apparatus 1 according to the second embodiment. The image display apparatus 1 includes a communication unit 301, a request management unit 502, an input unit 503, an acquired image transmission unit 504, a display unit 505, a device information management unit 506, a file management unit 507, a storage unit 508, displayed image information 511, device information 512, and an image file 513.

These units may be realized by processes that the CPU 101 is caused to execute by one or more programs installed in the image display apparatus 1. Furthermore, the image display apparatus 1 uses the storage unit 508. The storage unit 508 may be realized by the storage device 102 included in the image display apparatus 1, the storage medium 110 such as a flash memory connected to the image display apparatus 1, or an external storage device connected to the image display apparatus 1 via the network 3. The storage unit 508 stores the displayed image information 511, the device information 512, and the image file 513.

The request management unit 502 receives a request from the communication unit 301 or the input unit 503, and passes a process to a processing unit according to the request. The input unit 503 receives an operation with respect to the image display apparatus 1 from the user.

The acquired image transmission unit 504 generates a screen shot by capturing a screen of the image display apparatus 1, and sends the generated screen shot (hereinafter, “acquired image 2630”) to the terminal 2 via the communication unit 301. Furthermore, the acquired image transmission unit 504 may process the acquired image 2630, and send the processed acquired image 2630 to the terminal 2 via the communication unit 301. Furthermore, the acquired image transmission unit 504 may periodically send the acquired image 2630 to the terminal 2.

The display unit 505 displays the image received from the terminal 2 or the image file 513 stored in the storage unit 508, on a screen, via the light source 107 and the lens 108.

The device information management unit 506 sets or reads the device information 512 and the displayed image information 511 stored in the storage unit 508. The file management unit 507 reads the image file 513 stored in the storage unit 508.

The displayed image information 511 is information relevant to the image displayed on the screen of the image display apparatus 1, and includes an image display state 2501, the file name 2502 of the image, a user name of the terminal 2 (hereinafter, “terminal user name 2503”), an interrupt connection possibility setting 2504, and an image acquisition possibility setting 2505.

Here, the image display state 2501 is a setting value indicating whether an image is displayed on the screen of the image display apparatus 1, and either one of “displayed” or “not displayed” is set. The interrupt connection possibility setting 2504 is a setting value indicating whether to allow an image already displayed on the screen of the image display apparatus 1 to be replaced with an image sent from another terminal 2, when another terminal 2 attempts to connect to the image display apparatus 1 and send an image, in a state where an image is displayed on the screen of the image display apparatus 1. Ether one of “interrupt possible” or “interrupt rejected” is set as the interrupt connection possibility setting 2504. The image acquisition possibility setting 2505 is a setting value indicating whether to allow the image display apparatus 1 to send the acquired image 2630 to the terminal 2, and either one of “acquisition possible” or “acquisition rejected” is set. Note that when the image display state 2501 is set as “not displayed”, the interrupt connection possibility setting 2504 and the image acquisition possibility setting 2505 are set as “-”, which indicates there is no setting.

The device information 512 is information relevant to the image display apparatus 1, and includes the IP address of the image display apparatus 1 (hereinafter, “image display apparatus address 2602”), and an image display apparatus name 2601.

The image file 513 is a file of a photograph, a video, etc., stored in the storage medium 110 such as a flash memory.

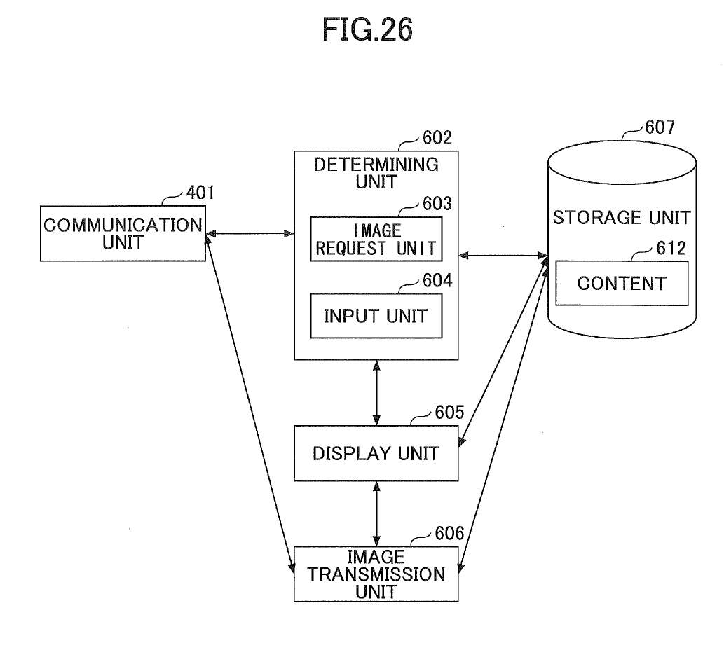

FIG. 26 illustrates an example of a functional block configuration of the terminal 2 according to the second embodiment. The terminal 2 includes a communication unit 401, a determining unit 602, a display unit 605, an image transmission unit 606, a storage unit 607, and a content 612 stored in the storage unit 607. Furthermore, the determining unit 602 includes an image request unit 603 and an input unit 604.

These units may be realized by processes that the CPU 201 is caused to execute by one or more programs installed in the terminal 2. Furthermore, the image display apparatus 1 uses the storage unit 607. The storage unit 607 may be realized by the NVRAM 204, the RAM 203, or an external storage device connected to the image display apparatus 1 via the network 3. The storage unit 607 stores an identifier list and the content 612.

The determining unit 602 determines the image display apparatus 1 to which an image is to be sent from the terminal 2, by displaying the acquired image 2630 on the screen of the terminal 2 and prompting the user to make a selection. The image request unit 603 searches for the image display apparatus 1 in the network 3, and requests the search-found image display apparatus 1 to send the acquired image 2630. The input unit 604 receives an operation with respect to the terminal 2 from the user.

The display unit 605 displays the acquired image 2630 or the content 612 on the screen provided in the terminal 2. The image transmission unit 606 sends the content 612 to the image display apparatus 1 via the communication unit 401.

### (4. Processing Procedures)

### [Acquired Image Display Process]

First, a description is given of processing procedures from when the image display apparatus 1 connected to the network 3 is searched to when an acquired image 2630 collected from the image display apparatus 1 is displayed on the screen of the terminal 2.

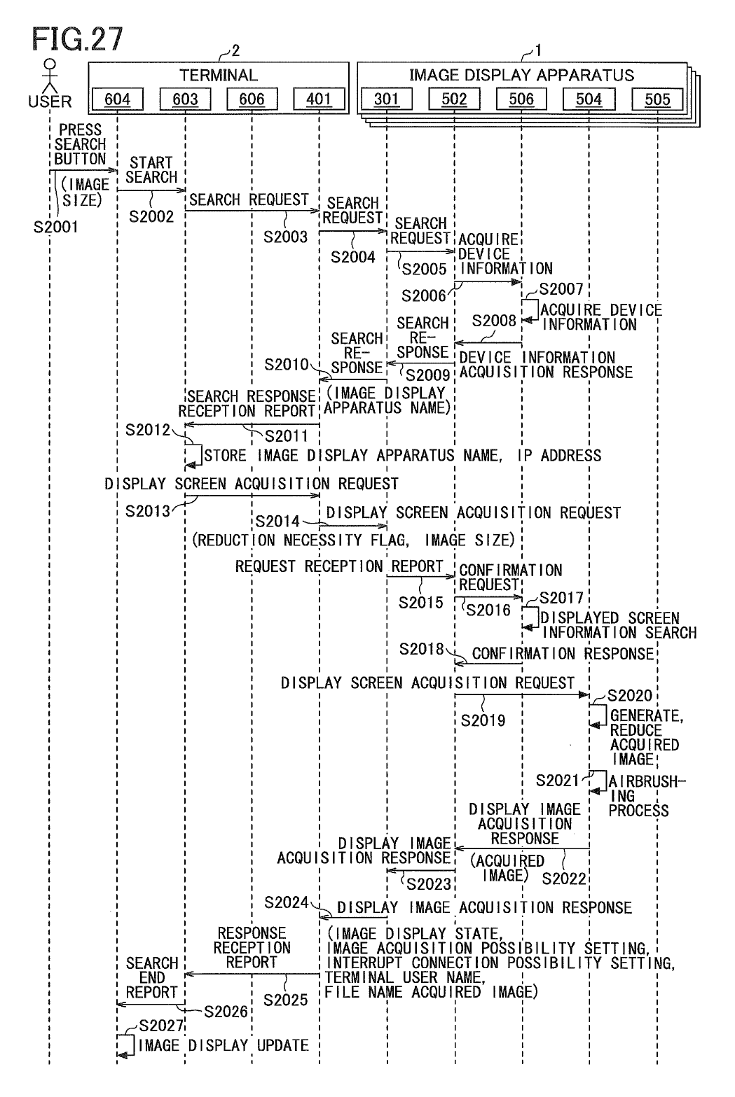

FIG. 27 is a sequence diagram illustrating an example of processing procedures for displaying the acquired image 2630 on the terminal 2.

According to a user operation, an instruction to start searching for the image display apparatus 1, is given to the terminal 2 (step S2001). Note that on the screen of the terminal 2, the user may be prompted to specify the image size of the acquired image 2630 in advance. The method of specifying the image size may be performed by specifying a specific size, such as 100 pixels in the vertical direction×100 pixels in the horizontal direction. In the following, a description is given of the processing procedures of step S2002 through S2027, in the case where the image size is specified in the screen of the terminal 2; however, when the image size is not specified, in step S2002 and steps S2013 through S2019, signals that do not include the image size are transmitted and received, and the process of reducing the acquired image 2630 in step S2020 is skipped.

In step S2002, the input unit 604 sends a report indicating search start including the specified image size, to the image request unit 603. Next, the image request unit 603 sends a search request to the communication unit 401 (step S2003), and stores the reported image size.

The communication unit 401 that has received the search request sends the search request to the network 3 to which the terminal 2 is connected (step S2004). The search request is performed by broadcast communication, and the search request reaches all image display apparatuses 1 connected to the network 3.

The communication unit 301 of the image display apparatus 1 that has received the search request, reports to the request management unit 502 that a search request has been received (step S2005). Next, the request management unit 502 sends a device information acquisition request to the device information management unit 506 (step S2006). The device information management unit 506 acquires, from the device information 512 stored in the storage unit, the image display apparatus name 2601 and the image display apparatus address 2602 (step S2007), and sends a device information acquisition response including the acquired image display apparatus name 2601 and the image display apparatus address 2602, to the request management unit 502 (step S2008). Next, the request management unit 502 sends a search response including the image display apparatus name 2601 and the image display apparatus address 2602, to the communication unit 301 (step S2009).

The communication unit 301 sends, to the terminal 2, a search response in which the transmission source IP address is the image display apparatus address 2602 received from the request management unit 502, with the image display apparatus name 2601 attached to the response (step S2010).

When the communication unit 401 of the terminal 2 receives the search response from the image display apparatus 1, the communication unit 401 sends, to the image request unit 603, a search response reception report including the image display apparatus name 2601 and the image display apparatus address 2602 (step S2011), and the image request unit 603 stores the received image display apparatus name 2601 and the image display apparatus address 2602 (step S2012). As described above, the search request sent from the terminal 2 is sent by broadcast communication, and therefore the processes of steps S2005 through S2010 are executed by all of the image display apparatuses 1 that have received the search request from the terminal 2. Therefore, the processes of steps S2011 and S2012 are executed with respect to each of the image display apparatuses 1 that have returned a search response to the terminal 2 in step S2010.

The image request unit 603 sends, to the communication unit 401, a display image acquisition request including the image size stored in step S2002 and the image display apparatus address 2602 stored in step S2012, with respect to each of the image display apparatuses 1 that have returned a search response to the terminal 2 in step S2010 (step S2013).

Next, the communication unit 401 sends, to each of the image display apparatuses 1, a display image acquisition request including a reduction necessity flag and the image size (step S2014). Here, the reduction necessity flag is a flag that is set when the image size is specified. When the image size is specified, “reduction necessary” is set in the reduction necessity flag, and when the image size is not specified, “reduction unnecessary” is set in the reduction necessity flag.

The communication unit 301 of the image display apparatus 1 that has received the display image acquisition request, sends a request reception report including the image size, to the request management unit 502 (step S2015). Next, the request management unit 502 sends a confirmation request to the device information management unit 506 (step S2016), and the device information management unit 506 searches the displayed image information 511 (step S2017), and sends a confirmation response including parameters of the displayed image information 511, to the request management unit 502 (step S2018).

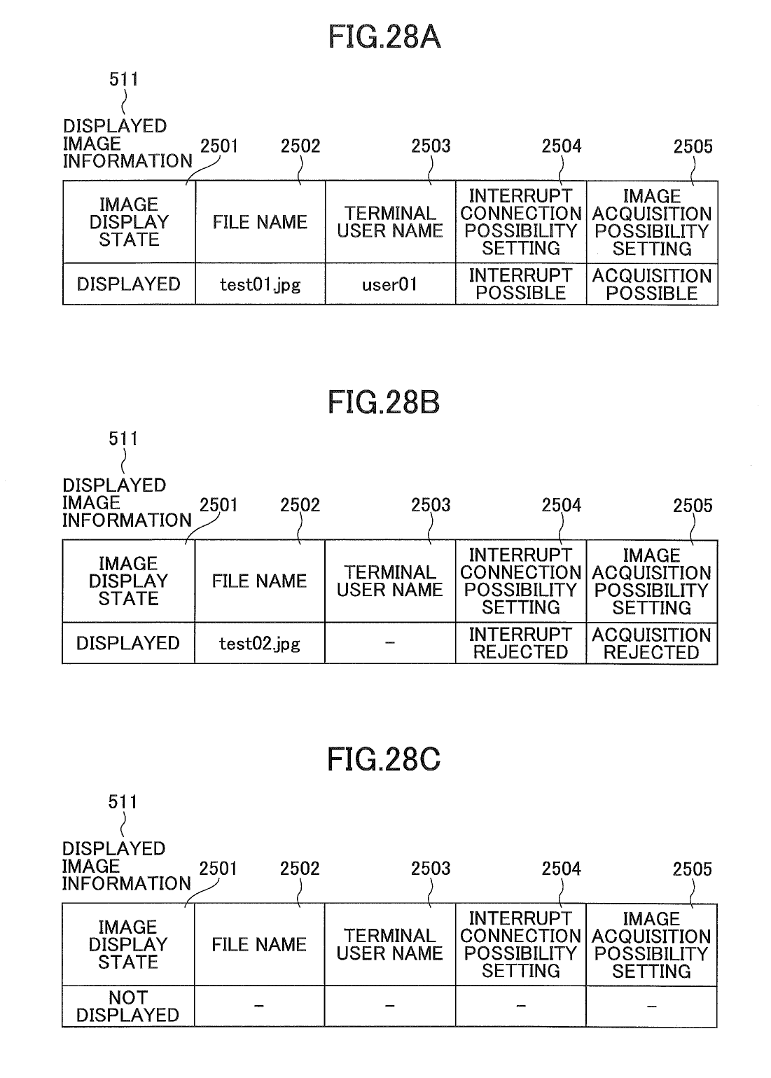

FIGS. 28A through 28C illustrate examples of the displayed image information. FIG. 28A illustrates a setting example of the displayed image information 511, in a case where an image displayed on the screen of the image display apparatus 1 is an image sent from the terminal 2. FIG. 28B illustrates a setting example of the displayed image information 511, in a case where an image displayed on the screen of the image display apparatus 1 is an image stored in the storage medium 110, etc., connected to the image display apparatus 1. In the terminal user name 2503, “-” indicating that there is no setting, is set. FIG. 28C illustrates a setting example of the displayed image information 511, in a case where nothing is displayed on the screen of the image display apparatus 1. In the items other than the image display state 2501,

“-” indicating that there is no setting, is set.

Among the received parameters of the displayed image information 511, when the image acquisition possibility setting 2505 is “acquisition possible”, the request management unit 502 sends a display image acquisition request including the image size, to the acquired image transmission unit 504 (step S2019). When the image acquisition possibility setting 2505 is “acquisition rejected”, or when the image display state 2501 is “not displayed”, the acquired image 2630 is not generated, and therefore step S2019 is not executed and the process proceeds to step S2023.

The acquired image transmission unit 504 generates the acquired image 2630 by capturing the screen of the image display apparatus 1, and reduces the generated acquired image 2630 into the specified size (step S2020). Next, the acquired image transmission unit 504 performs an airbrushing process on the reduced acquired image 2630 (step S2012). The airbrushing process is performed for the purpose of making the detailed information such as characters illegible from the acquired image 2630. Therefore, any other image processing means is applicable, as long as the same effects can be achieved, such as a mosaic process. Note that the airbrushing process does not always need to be executed; the airbrushing process may be executed only when it is set to be executed in advance.

Next, the acquired image transmission unit 504 sends the acquired image 2630 to the request management unit 502 (step S2022), and the request management unit 502 sends, to communication unit 301, a display image acquisition response including the parameters of the displayed image information 511 and the acquired image 2630 included in the confirmation response received in step S2018 (step S2023).

The communication unit 301 sends a display image acquisition response including the parameters of the displayed image information 511 and the acquired image 2630, to the terminal 2 (step S2024). Here, when the processes of steps S2019 through S2022 of generating the acquired image 2630 are skipped, the communication unit 301 sends a display image acquisition response including only the parameters of the displayed image information 511, to the communication unit 301. In the following, a description is given of a case where the acquired image 2630 is generated; however, when the process of generating the acquired image 2630 is skipped, in the processes of steps S2025 through S2027, signals that do not include the acquired image 2630 are transmitted and received.

When the communication unit 401 of the terminal 2 receives the display image acquisition response, the communication unit 401 sends a response reception report including the parameters of the image request unit 603 and the acquired image 2630, to the image request unit 603 (step S2025). Next, the image request unit 603 sends, to the input unit 604, a search end report including the parameters of the displayed image information 511, the acquired image 2630, the image display apparatus name 2601, and the image display apparatus address 2602 (step S2026). Note that in step S2014, the communication unit 401 sends a display image acquisition request to each of the image display apparatuses 1, and therefore the processes of steps S2015 through S2024 are executed by each of the each of the image display apparatuses 1. Therefore, the processes of steps S2025 and S2026 are executed with respect to each of the image display apparatuses 1 that have returned a display image acquisition response to the terminal 2 in step S2024.

Next, the input unit 604 updates the screen of the terminal 2, based on the parameters of the displayed image information 511, the acquired image 2630, the image display apparatus name 2601, and the image display apparatus address 2602, received from each of the image display apparatuses 1 (step S2027).

Note that the request management unit 502, the device information management unit 506, and the acquired image transmission unit 504 may periodically execute the processes of steps S2016 through S2023, to periodically send the acquired image 2630 to the terminal 2. The acquired image 2630 displayed on the screen of the terminal 2 can be periodically updated to the newest acquired image 2630.

Furthermore, when the request management unit 502, the device information management unit 506, and the acquired image transmission unit 504 periodically execute the processes of steps S2016 through S2023, the acquired image transmission unit 504 may generate the acquired image 2630, only when the image displayed on the screen of the image display apparatus 1 changes. It is possible to reduce the processing load and the network load of sending the acquired image 2630 to the terminal 2.

Furthermore, when the request management unit 502, the device information management unit 506, and the acquired image transmission unit 504 periodically execute the processes of steps S2016 through S2023, the acquired image transmission unit 504 may generate the acquired image 2630, only when the image displayed on the screen of the image display apparatus 1 changes by a predetermined amount. It is possible to reduce the processing load and the network load of sending the acquired image 2630 to the terminal 2. In order to detect that the image displayed on the screen of the image display apparatus 1 has changed by a predetermined amount, for example, the amount of difference between two acquired images 2630 may be numerically converted, and it may be determined that the image has changed by a predetermined amount when the value obtained by the numerical conversion exceeds a certain threshold.

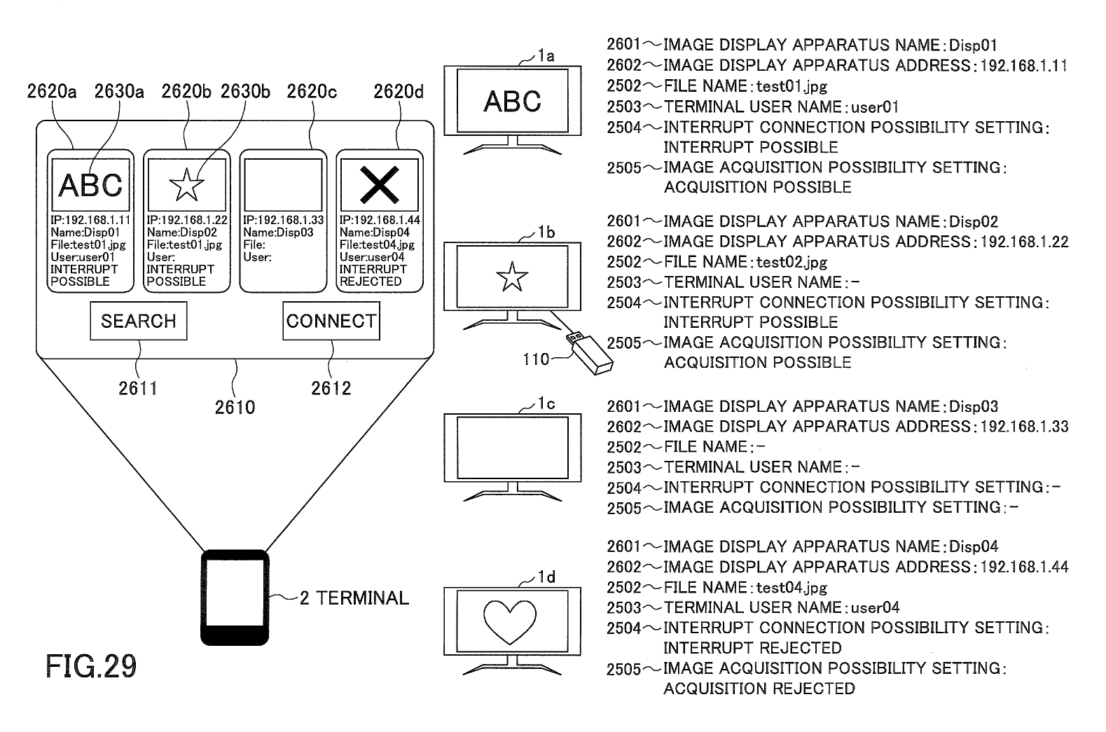

FIG. 29 illustrates examples of acquired images displayed on the screen of the terminal. On a screen 2610 of the terminal 2, the acquired image 2630, the image display apparatus name 2601, the image display apparatus address 2602, the file name 2502, the terminal user name 2503, and the interrupt connection possibility setting 2504, which have been acquired from each of the image display apparatuses 1, are displayed so as to fit in a display area 2620 provided in each of the image display apparatuses 1.

In the display examples of FIG. 29, an acquired image 2630a acquired from an image display apparatus 1a is displayed in a display frame 2620a, and an acquired image 2630b acquired from an image display apparatus 1b is displayed in a display frame 2620b. Note that the image display apparatus 1b is displaying the image file 513 stored in the storage medium 110, and therefore a terminal user name 2503 is not displayed in the display frame 2620b. Furthermore, the image display apparatus 1c is in a not displayed state, and therefore only the image display apparatus name 2601 and the image display apparatus address 2602 acquired from the image display apparatus 1c are displayed in the display frame 2620c. In the image display apparatus 1d, the image acquisition possibility setting 2505 is set as “acquisition rejected”, and therefore the acquired image 2630 is not displayed in the display frame 2620d.

A search button 2611 is a button that is used when starting to search for the image display apparatus 1, and by pressing the search button 2611, the process of step S2002 of FIG. 27 is started. Although not illustrated, when the search button 2611 is pressed, a screen prompting to input the image size may be displayed.

A connection button 2612 is a button that is pressed when sending the content 612 to the image display apparatus 1. Although not illustrated, when the connection button 2612 is pressed, a screen prompting selection of the content 612, and input of the image acquisition possibility setting 2505 and the interrupt connection possibility setting 2504, may be displayed.

### [Content Transmission Process]

Next, a description is given of processing procedures from when the content 612 is sent from the terminal 2 to the image display apparatus 1, to when the content 612 is displayed on the screen of the image display apparatus 1.

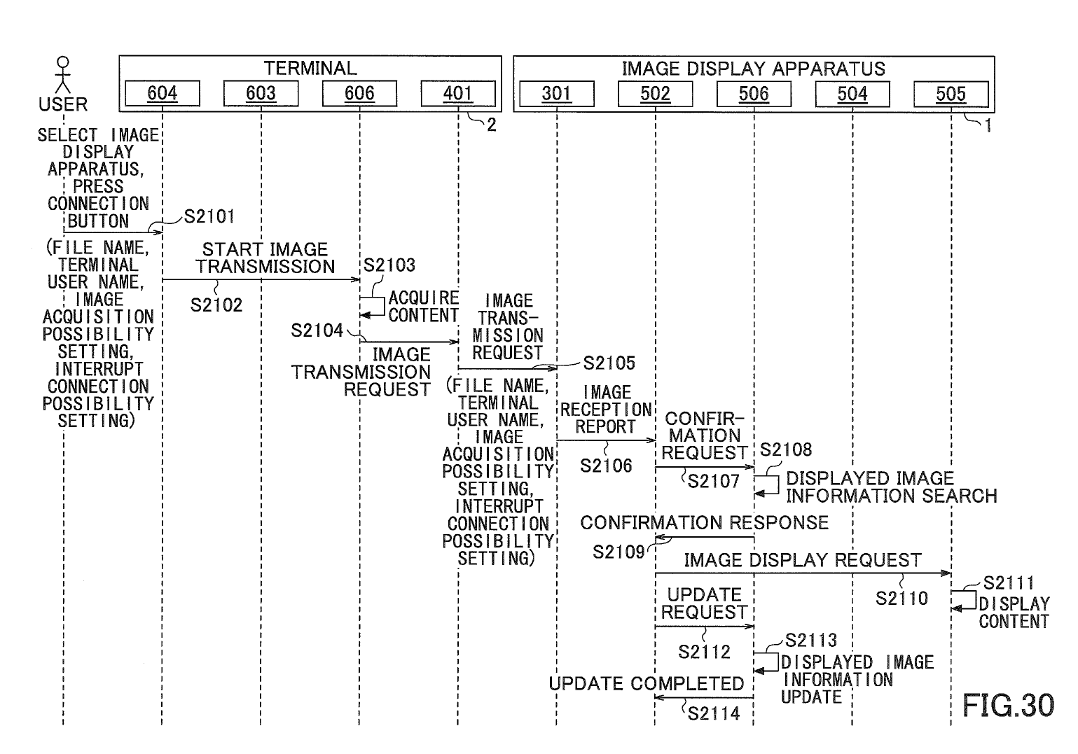

FIG. 30 is a sequence diagram illustrating an example of processing procedures for sending a content from the terminal to the image display apparatus.

First, the user selects at least one image display apparatus 1 from among the image display apparatuses 1 displayed on the screen of the terminal 2, and presses the connection button 2612, to instruct to send the content 612 to the image display apparatus 1 (step S2101). Note that the user may be prompted to input the file name 2502 of the content 612 to be sent, and the image acquisition possibility setting 2505 or the interrupt connection possibility setting 2504.

Next, the input unit 604 sends, to the image transmission unit 606, an image transmission start signal including the file name 2502 of the content 612 to be sent, the terminal user name 2503, the image acquisition possibility setting 2505, and the interrupt connection possibility setting 2504 (step S2102), and the image transmission unit 606 acquires the content 612 stored in the storage unit 607 (step S2103).

Next, the image transmission unit 606 sends, to the communication unit 401, an image transmission request including the acquired content 612, the file name 2502, the terminal user name 2503, the image acquisition possibility setting 2505, and the interrupt connection possibility setting 2504 (step S2104), and the communication unit 401 sends, to the image display apparatus 1, an image transmission request including the content 612, the file name 2502, the terminal user name 2503, the image acquisition possibility setting 2505, and the interrupt connection possibility setting 2504 (step S2105).

When the communication unit 301 of the image display apparatus 1 receives the image transmission signal, the communication unit 301 sends an image reception report to the request management unit 502 (step S2106). Next, the request management unit 502 sends a confirmation request to the device information management unit 506 (step S2107). The device information management unit 506 searches the displayed image information 511 (step S2108), and sends a confirmation response including the parameters of the displayed image information 511, to the request management unit 502 (step S2109).

When the image display state 2501 in the displayed image information 511 is “not displayed”, or when the interrupt connection possibility setting 2504 is “interrupt possible”, the request management unit 502 sends an image display request including the content 612 to the display unit 505 (step S2110), and when the interrupt connection possibility setting 2504 is “interrupt rejected”, the request management unit 502 does not send an image display request to the display unit 505 (that is, the process of step S2110 is not executed), and the process ends. Next, the display unit 505 displays the content 612 on the screen of the image display apparatus 1 (step S2111).

After the process of step S2110, the request management unit 502 sends, to the device information management unit 506, an update request including the image display state 2501 set as “displayed”, the file name 2502, the terminal user name 2503, the image acquisition possibility setting 2505, and the interrupt connection possibility setting 2504 (step S2112).

The device information management unit 506 updates the parameters of the displayed image information 511 by the image display state 2501, the file name 2502, the terminal user name 2503, the image acquisition possibility setting 2505, and the interrupt connection possibility setting 2504 received in step S2112 (step S2113), and reports the update completion to the request management unit 502 (step S2114).

Next, a description is given of processing procedures from when the storage medium 110 is connected to the image display apparatus 1, to when the image file 513 stored in the storage medium 110 is displayed on the screen of the image display apparatus 1.

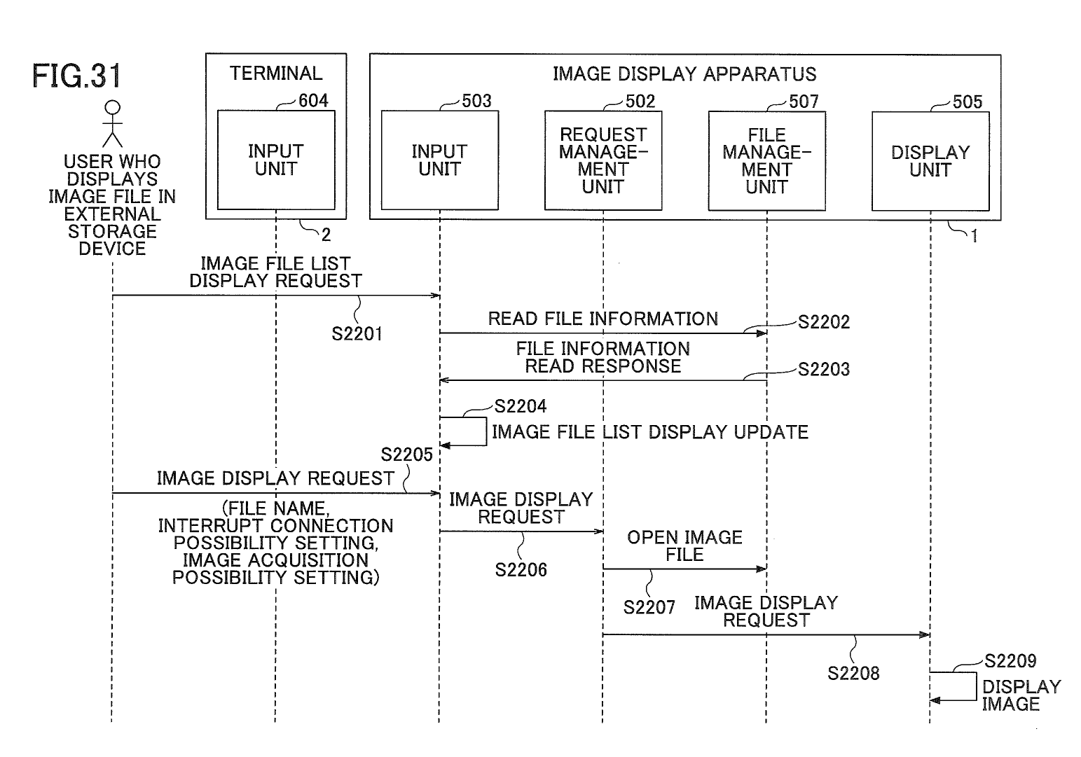

FIG. 31 is a sequence diagram illustrating an example of processing procedures for displaying an image file stored in a storage medium on the screen of the image display apparatus.

First, when the user operates the image display apparatus 1 (step S2201), the input unit 503 sends a file information read signal to the file management unit 507 (step S2202). Next, the file management unit 507 sends a list of image files 513 stored in the storage medium 110, to the input unit 503 (step S2203), and the input unit 503 displays the list of image files 513 (step S2204).

Next, when the file name 2502 of the image file 513 to be displayed on the screen of the image display apparatus 1, the interrupt connection possibility setting 2504, and the image acquisition possibility setting 2505 are specified by the user's operation (step S2205), the input unit 503 sends, to the request management unit 502, an image display request including the file name 2502 of the image file 513, the interrupt connection possibility setting 2504, and the image acquisition possibility setting 2505 (step S2206).

The request management unit 502 requests the file management unit 507 to turn the image file 513 having the specified file name 2502, into an accessible state (step S2207). Next, the request management unit 502 sends an image display request to the display unit 505 (step S2208), and the display unit 505 displays the image file 513 on the screen of the image display apparatus 1 (step S2209).

After executing step S2208, the request management unit 502 executes the processes of steps S2112 through S2114 of FIG. 30. That is, the request management unit 502 sends, to the device information management unit 506, the file name 2502 of the image file 513, the interrupt connection possibility setting 2504, and the image acquisition possibility setting 2505 received at step S2206, and the device information management unit 506 updates the displayed image information 511.

Note that in the processing procedures in FIG. 31, the image display apparatus 1 displays the image file 513 regardless of the interrupt connection possibility setting 2504 in the displayed image information 511; however, the same processes as steps S2107 through S2109 of FIG. 30 may be executed between step S2206 and step S2207. That is, when the image display state 2501 is “not displayed” or the interrupt connection possibility setting 2504 is “interrupt possible” in the displayed image information 511, the image display apparatus 1 may send an image display request to the display unit 505 (step S2208), and when the interrupt connection possibility setting 2504 is “interrupt rejected”, the image display apparatus 1 may end the process without executing the process of step S2208.

### [Connection Confirmation Process]

Next, a description is given of processing procedures for confirming the connection between the terminal 2 and the image display apparatus 1, by displaying a confirmation tag sent from the terminal 2 on the image display apparatus 1. Here, a confirmation tag is a combination of an arbitrary images or characters. The confirmation tag sent from the terminal 2 is displayed by being superposed on an image displayed on the screen of the image display apparatus 1. Accordingly, it is possible to more reliably determine whether the image display apparatus 1 that is the connection destination is the target image display apparatus 1.

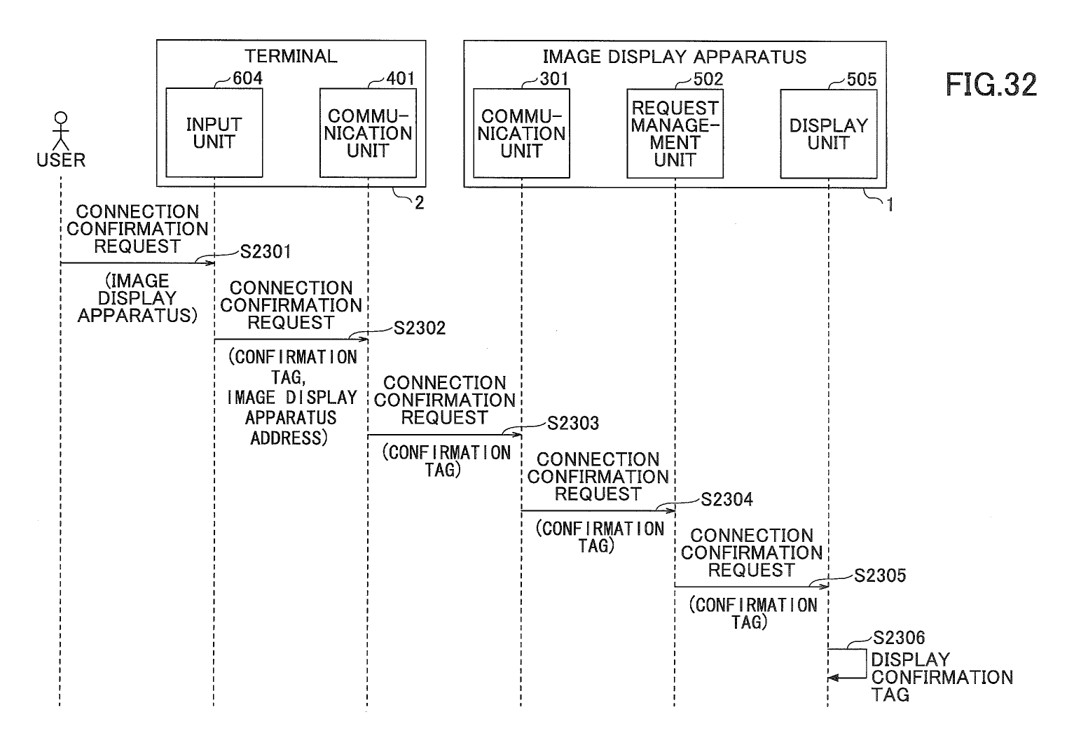

FIG. 32 is a sequence diagram illustrating an example of processing procedures for confirming the connection between the terminal 2 and the image display apparatus.

By a user's operation (step S2301), the input unit 604 sends a connection confirmation request including the confirmation tag and the image display apparatus address 2602, to the communication unit 401 (step S2302). Here, in step S2301, for example, the image display apparatus 1 to which the confirmation tag is to be sent may be selected by selecting at least one of the display frames 2620a through 2620d in the screen 2610 illustrated in FIG. 29.

Next, the communication unit 401 sends a connection confirmation request including the confirmation tag, to the image display apparatus 1 indicated by the received image display apparatus address 2602 (step S2303).

The communication unit 301 of the image display apparatus 1 reports that the connection confirmation request has been received to the request management unit 502 (step 2304), and the request management unit 502 sends a connection confirmation request including the confirmation tag to the display unit 505 (step S2305). The display unit 505 displays the confirmation tag on the screen of the image display apparatus 1 (step S2306).

As described above, according to the second embodiment, the user compares the images displayed in a list on the terminal 2, with the images displayed on the screens of the respective image display apparatuses 1, and therefore it is possible to reduce the possibility of connecting the terminal 2 to the wrong image display apparatus 1.

Furthermore, even when the image display apparatus 1 is in a used state, the user is able to select the target image display apparatus 1 that is the connection destination, without stopping the usage of the image display apparatus 1.

Note that in the second embodiment, the acquired image 2630 is an example of an identifier. Furthermore, the acquired image transmission unit 504 is an example of a first sending unit. Furthermore, the image transmission unit 606 is an example of a second sending unit. Furthermore, the display unit 505 is an example of a first display unit. Furthermore, the display unit 605 is an example of a second display unit. Furthermore, the file name 2502 is an example of a name of the image. Furthermore, the terminal user name 2503 is an example of terminal information.

According to one embodiment of the present invention, an image information display system is provided, by which an information processing terminal can easily identify the appropriate image display apparatus.

The image display system, the terminal, and the image display apparatus are not limited to the specific embodiments described herein, and variations and modifications may be made without departing from the spirit and scope of the present invention. Furthermore, the orders of steps in the sequences and flowcharts may be replaced as long as there is no contradiction.

All of or part of the above embodiments may be implemented by programs. These programs may be stored in the storage medium 110.

Furthermore, the embodiments may be partially combined.

The present application is based on and claims the benefit of priority of Japanese Priority Patent Application No. 2014-168217, filed on Aug. 21, 2014, the entire contents of which are hereby incorporated herein by reference.

What is claimed is:

1. An image display system in which a terminal and a plurality of image display apparatuses are connected to each other via a network, the image display system comprising:
a first sending unit configured to send an identifier that identifies each of the plurality of image display apparatuses, to the terminal;
a determining unit configured to determine at least one of the plurality of image display apparatuses based on the received identifier;
a second sending unit configured to send a content from the terminal to the at least one of the plurality of image display apparatuses that has been determined; and
a first display unit configured to display the received content on a screen of the at least one of the plurality of image display apparatuses.

2. The image display system according to claim 1, further comprising:
a first storage unit configured to store the identifier in each of the plurality of image display apparatuses; and
a second storage unit configured to store, in the terminal, an identifier list including the identifiers of the plurality of image display apparatuses, wherein
the determining unit determines the at least one of the plurality of image display apparatuses when a comparison result obtained by comparing the received identifier with the identifier list satisfies a predetermined condition.

3. The image display system according to claim 2, further comprising:
a second display unit configured to display an image on a screen of the terminal, wherein
the first sending unit sends, to the terminal, the identifier and also a request to send the content, and
the second sending unit generates the content by capturing the image displayed on the screen of the terminal, when the request to send the content is received.

4. The image display system according to claim 3, further comprising:
an identifier generating unit configured to generate the identifier, wherein
the second storage unit stores, in the identifier list, the identifier generated by the identifier generating unit.

5. The image display system according to claim 4, wherein
the second storage unit stores, in the identifier list, the identifier generated by the identifier generating unit, when a number of the identifiers stored in the identifier list does not exceed a predetermined value.

6. The image display system according to claim 4, wherein
the second storage unit stores, in the identifier list, the identifier generated by the identifier generating unit, by deleting one of the identifiers stored in the identifier list, when a number of the identifiers stored in the identifier list exceeds a predetermined value.

7. The image display system according to claim 2, further comprising:
an input unit configured to receive input from a user with respect to the terminal, wherein
the second storage unit deletes one of the identifiers from the identifier list, based on the input from the input unit.

8. The image display system according to claim 7, wherein
the second storage unit stores, in the identifier list, a number of times a request to send the content is received, in association with each of the plurality of image display apparatuses, and
the determining unit determines the at least one of the plurality of image display apparatuses, when the request to send the content is received, and the number of times the request to send the content is received does not exceed a predetermined number of times.

9. The image display system according to claim 7, wherein
the second storing unit stores, in the identifier list, a period during which a request to send the content can be received, in association with each of the plurality of image display apparatuses, and
the determining unit determines the at least one of the plurality of image display apparatuses, when the request to send the content is received, and the period has not elapsed from a time when the request to send the content has been received a first time.

10. The image display system according to claim 9, wherein
the input unit receives the input of the period from the user, and
the second storing unit stores the period in the identifier list in association with each of the plurality of image display apparatuses.

11. The image display system according to claim 7, wherein
the determining unit determines the at least one of the plurality of image display apparatuses, when the request to send the content is received, and a predetermined period has not elapsed from a time when the request to send the content has been received a last time.

12. The image display system according to claim 1, further comprising:
a second display unit configured to display the identifier on a screen of the terminal, wherein
the first sending unit generates the identifier from an image displayed on the screen of the image display apparatus and sends the generated identifier to the terminal,
the second display unit prompts a user to select the identifier by displaying the received identifier on the screen of the terminal, and
the determining unit determines the at least one of the plurality of image display apparatuses based on the selection of the identifier.

13. The image display system according to claim 12, wherein
the first sending unit generates the identifier from an image displayed on the screen of the image display apparatus, and sends a name of the image displayed on the screen of the image display apparatus to the terminal, and
the second display unit displays the received identifier and the name of the image, on the screen of the terminal.

14. The image display system according to claim 12, wherein
the first sending unit sends, to the terminal, terminal information of a different terminal from the terminal, together with the generated identifier, when the identifier has been generated from the screen of the image display apparatus displaying the content received from the different terminal, and
the second display unit displays the received identifier and the terminal information on the screen of the terminal.

15. The image display system according to claim 12, wherein
the second sending unit sends a confirmation tag to the image display apparatus, and
the first display unit displays the confirmation tag on the screen of the image display apparatus.

16. The image display system according to claim 12, wherein
the first sending unit is able to reject to send the identifier, when a request to send the identifier is received.

17. The image display system according to claim 12, wherein
the first display unit reports, to the terminal, that the image display apparatus is in a state where the content cannot be displayed on the screen of the image display apparatus, and
the second display unit displays, on the screen of the terminal, a message indicating that the report has been received.

18. The image display system according to claim 12, wherein
the first sending unit generates the identifier by capturing the screen of the image display apparatus and performing a predetermined process on the captured image, and sends the generated identifier to the terminal.

19. A terminal connected to a plurality of image display apparatuses via a network, the terminal comprising:
a determining unit configured to determine at least one of the plurality of image display apparatuses based on identifiers received from the plurality of image display apparatuses; and
a sending unit configured to send, to the at least one of the plurality of image display apparatuses that has been determined, a content to be displayed on a screen of the at least one of the plurality of image display apparatuses.

20. An image display apparatus connected to a terminal via a network, the image display apparatus comprising:
a sending unit configured to send an identifier that identifies the image display apparatus, to the terminal;
a communication unit configured to receive a content from the terminal that has determined to send the content to the image display apparatus based on the identifier; and
a display unit configured to display the content.
